(19) United States
(12) Patent Application Publication
(10) Pub. No.: US 2010/0082380 A1
(43) Pub. Date: Apr. 1, 2010

(54) MODELING AND MEASURING VALUE ADDED NETWORKS

(75) Inventors: Eric S. Merrifield, JR., Seattle, WA (US); Chad K. Corneil, Snoqualmie, WA (US); Daniel C. Brown, Hellerup (DK)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/242,412

(22) Filed: Sep. 30, 2008

(51) Int. Cl. G06Q 10/00

(52) U.S. Cl. 705/7

(57) ABSTRACT

The present invention extends to methods, systems, and computer program products for modeling and measuring value added networks. Value added networks are modeled in accordance with a structured data model that defines data formats for business capability attributes. The structured data model can include a capability modeling schema having data format definitions that define how business capability attributes are to be represented. Value added networks can also be mapped such that users can visualize and navigate a value added network. A pre-defined resource vocabulary is utilized to assist in determining if a business capability change is worthwhile. The pre-defined resource vocabulary provides a mechanism for a plurality of participants in a value added network to consider business capability changes in a uniform, repeatable, and consistent manner.

### CROSS-REFERENCE TO RELATED APPLICATIONS

Not Applicable.

### BACKGROUND

### 1. Background and Relevant Art

Businesses have complex operations. An understanding of these operations is important to a business in order to, for example, prepare for change, account for costs, etc. Accordingly, various mechanisms have been developed to model and represent businesses. Some mechanisms include manual generation of diagrams that represent business processes that describe how work is done. For example, trained individuals can analyze all aspects of a business to identify business capabilities and interrelationships and interdependencies between the business processes. Based on the analysis, the trained individuals can generate the representative diagrams. However, accurate analysis of a business from a business process point-of-view can take an extended period of time. Further, once representative diagrams are generated such diagrams are not easily modified.

Unfortunately, since many business processes are dynamic (i.e., can change over time), a manually generated representation of business processes may be outdated before it is even completed. Further, even if a manually generated representation of business processes were accurate at the time it was completed, any change in business processes after the business representation is generated would cause the business representation to be incorrect. Thus, manually generated representations provide limited, if any, ability for a business to determine how simulated and/or hypothetical changes to various business capabilities would affect the business.

At least in part as a result of the deficiencies in manually generated business representations, some computerized mechanisms have been developed to generate business representations. These computerized mechanisms use various techniques to represent business and the required business functions mostly focused on modeling business processes and detailed procedures that support those processes. For example, some computerized mechanisms present a graphical view of business processes at a user-interface. To some limited extent, these graphical views can be altered to simulate the effect of different business capabilities on a business.

However, most of these computerized mechanisms focus on “how” the business is executed, conflating (or combining) various different layers (or types) of input data, such as, for example, organizational structures, procedures, process flows, and supporting technology. The stability of the input data (i.e., the half life of the information represented) potentially varies dramatically between the different input layers (or types), rendering the useful life time of a generated view only as valid as the least stable input. Conflating (or combining) interrelated, yet non-dependent, input data together can also result in obscured views of how a business functions and lead to unnecessary and costly improvement efforts of the modeled business, without the ability to determine the effect of changes in each individual layer.

Further, computerized mechanisms often include hard-coded data types and hard-coded representations for business modeling input data. These hard-coded data types and representations can be difficult to alter without access to source code. Thus, the flexibility and extensibility of modeling businesses and generating corresponding views is limited. For example, it may difficult to alter pre-defined data formats such that a business capability can be represented in a different way or such that a previously undefined business capability can be added.

All of the above for mentioned difficulties associated with modeling businesses limit the usefulness of visual presentations of such models. For example, most visual presentations of business models, such as, for example, business maps, center on data representations in the context of specific isolated tasks or activities. Visualizing and navigating to adjunct, potentially useful business data, organizations structure, partners, or relevant business process flows, is cumbersome and often impossible. For example, there is typically no mechanism to visually navigate from data in one business layer, such as, for example, a business process flow layer, to data in another business layer, such as, for example, a organizational structure layer indicating personnel that implement/manage a business process flow.

Additionally, there is typically no mechanism to visually navigate to and/or from data in a business layer to data in other relevant non-business layers, such as, for example, a geographic layer. For example, there may be no way to navigate from a business flow map to a geographic map that indicates where the business process flow occurs.

Further, there is typically no mechanism to visually represent varied levels of detail of networked business elements. That is, typical business visualization techniques lack mechanisms to focus (or “zoom in”) and abstract (or “zoom out”) levels of detail as specified by a user. Thus, a user may be forced to use a business map having either to much or to little detail for a specific task. As a result, on one hand, a user may get bogged down in unnecessary details that make performing the task inefficient. On the other hand, a user may lack sufficient details for completing the task at all.

Value added business networks (or chains) introduce further complexity when attempting to model and visual business functionality. A value added business network (or chain) can include a number of entities (e.g., corporations, organizations, partnerships, etc.) that interoperate to provide a stream of work. Input (e.g., iron ore) is received at an initial entity, one or more intermediary entities perform operations, and then a final entity produces output (e.g., steel bolts). Along the network, output from a prior entity is provided as input to the next entity. Thus, the performance of each entity in the value added business network impacts the overall performance of the stream of work. Accordingly, over performance or under performance at any entity can improve or degrade respectively the performance of the stream of work.

The ability of an entity to understand their participation in a value added business network is important to staying competitive in a given field. The need for this understanding is often useful to identify under performing or over performing business units, new competing products, regulatory changes, etc.

However, within a value added business network, there is typically no inter-entity visibility. That is, one entity typically has no mechanism to view the processes of another entity to better understand the functionality of a valued added network as a whole. Thus, an entity is unable to view other portions of the value added network that might be useful to increasing its own performance, and thus potentially also increase the performance of a corresponding stream of work. Accordingly, it can be difficult for an entity to determine how to improve its performance within a value added business network.

In addition, in most, if not all, value added business networks, there is no common vocabulary for discussing changes between entities. Thus, if over performance or under performance is identified, discussions of changes within and/or across a value added business network are not always based on a common vocabulary. Without a common vocabulary to discuss potential value added business network changes and their impact, information exchanged with respect to such changes is often inaccurate and/or incomplete information. As such, implementing changes and/or benefits of investing in changes can not be determined or may be incorrect.

Without a common vocabulary to determine when changes to a value added business network may or may not be of value, it is also difficult to formulate computer based tools and methods to assist in determining such changes might be valuable As a result, organizations can have further difficulties appropriately incorporating changes into existing business models. For example, it can be difficult for an entity to differentiate particular business components that can be changed to increase the performance of a stream of work.

Even if a common vocabulary can be identified, the common vocabulary is typically only useful under a static view of a value added network. If portions of the value added network subsequently change, the vocabulary loses meaning across the entities participating in the value added network. As more changes occur the value of the vocabulary is further reduced. As such, the exchange of meaningful and objective information can be difficult in value added networks with increased. For example, when entities participating in a value added network change it can be difficult to propagate the vocabulary to newer joining entities. Further, when the functionality of entities participating in a value added changes additions and/or updates to the vocabulary can be required before the impact of functionality changes can be measured.

### BRIEF SUMMARY

The present invention extends to methods, systems, and computer program products for modeling and measuring value added networks. In some embodiments, a computer system models and/or maps a value added network. The computer system accesses a plurality of business capability attributes. The plurality of business modeling attributes correspond to the business capabilities of a plurality of interconnected entities participating in a value added network. The value added network is configured to produce a stream of work. Business modeling attributes can potentially include visibility attributes used to limit the inter-entity visibility of capabilities, connectors, ports, and data within the value added network.

The computer system formats the accessed plurality of business capability attributes in accordance with data formats defined in a structured data model. Thus, the structured data model provides the plurality of entities with a common vocabulary for modeling business capabilities. The computer system models the value added network from the formatted business capability attributes.

Modeling the value added network can include modeling first and second business capabilities that are under the control of first and second entities in the value added network respectively. Modeling the value added network can also include modeling a connection between the first and second capabilities. The second business capability is potentially modeled such that only data used in generation of the stream of work is visible to the first entity. Modeling the value added network can also include modeling a connection between the first business capability and the second capability.

The computer system generates renderable the components of the value added network. Generation can include generating a renderable capability object for the first business capability and for the second business capability. Generation can also include generating a renderable relationship object for the connection between the first business capability and the second capability. The computer system visually renders the renderable objects as a navigable business architecture map that represents the configuration of the value added network. Rendering includes rendering the capability objects and the relationship object to reflect the relationship between the first business capability and the second business capabilities. The navigable business architecture map indicates boundaries between entities participating in the value added network.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that can be used to implement efficient and flexible business modeling based upon structured business capabilities.

FIG. 1B illustrates an example computer architecture that can be used to associate and visualize schematized business networks.

FIG. 1C illustrates a business architecture map for a value added network.

FIG. 1D illustrates a more detailed view of some business capabilities of the value added network in FIG. 1C.

FIG. 2 illustrates a portion of an example capability modeling schema that can be used for efficiently and flexibly business modeling based upon structured business capabilities.

FIGS. 3A and 3B illustrate a visual representation of a collection of business capabilities at varied levels of detail.

FIG. 3C illustrates an example of a modeled business capability.

FIG. 3D illustrates a first view of an example of a network of modeled business capabilities.

FIG. 3E illustrates a second view of the example of a network of modeled business capabilities.

FIG. 4 illustrates an example computer architecture that facilitates structured implementation of capability changes in a value added network.

FIG. 5 illustrates a change spectrum.

FIG. 6 illustrates an adaptability spectrum.

FIG. 7 illustrates an example flowchart of a method for visualizing a model of a value added network.

FIG. 8 illustrates an example flowchart of a method for implementing a structured capability change to some aspect of a value added network.

### DETAILED DESCRIPTION

The present invention extends to methods, systems, and computer program products for modeling and measuring value added networks. In some embodiments, a computer system models and/or maps a value added network. The computer system accesses a plurality of business capability attributes. The plurality of business modeling attributes correspond to the business capabilities of a plurality of interconnected entities participating in a value added network. The value added network is configured to produce a stream of work. Business modeling attributes can potentially include visibility attributes used to limit the inter-entity visibility of capabilities, connectors, ports, and data within the value added network.

The computer system formats the accessed plurality of business capability attributes in accordance with data formats defined in a structured data model. Thus, the structured data model providing provides the plurality of entities with a common vocabulary for modeling business capabilities. The computer system models the value added network from the formatted business capability attributes.

Modeling the value added network can include modeling first and second business capabilities that are under the control of first and second entities in the value added network respectively. Modeling the value added network can also include modeling a connection between the first and second capabilities. The second business capability is potentially modeled such that only data used in generation of the stream of work is visible to the first entity. Modeling the value added network can also include modeling a connection between the first business capability and the second capability.

The computer system generates renderable the components of the value added network. Generation can include generating a renderable capability object for the first business capability and for the second business capability. Generation can also include generating a renderable relationship object for the connection between the first business capability and the second capability. The computer system visually renders the renderable objects as a navigable business architecture map that represents the configuration of the value added network. Rendering includes rendering the capability objects and the relationship object to reflect the relationship between the first business capability and the second business capabilities. The navigable business architecture map indicates boundaries between entities participating in the value added network.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different types of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. In some embodiments, instructions can also be metadata, which is distinct from source code in an application. Metadata can be useful in a value added network where two or more entities satisfy a stream of work (e.g., WSDL defines the interfaces for exchanging data. As such, higher level metadata can describe a higher level of “business exchange. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In this description and in the following claims, “business capability attribute” is defined as any attribute that can be used to model a business capability or part of a business capability. Business capability attributes are defined to include: business capability data (what kind of data is used by the capability), business capability applications, and business capability communications.

Business capability attributes are also defined to include measurement and analysis attributes of a business capability. Measurement and analysis attributes can indicate how the success of a business capability is measured, who owns the business capability, who is the customer of the capability, notification criteria for variations in the business capability, workarounds if a business capability is not available, acceptable variations in inputs to and outputs of the business capability, the stability and/or volatility of the business capability, the importance of the capability, etc.

In this description and in the following claims, a “business relationship attribute” is defined as an attribute that can be used to model a relationship between a first business capability and a second different business capability A relationship can be, for example, a dependency, a connection, or a boundary. A dependency can indicate what has to occur for a modeled business capability to start, external events that occur for a business capability to stop, or other business capabilities that depend on the business capability. A connection indicates how one business capability relates to other business capabilities. A boundary indicates if influences on a business capability are internal (e.g., people, process, technology inside a company) or external (e.g., regulations, customers, partners, other participants in a value added network) to the business capability. Accordingly, a business relationship attribute can be used to model a relationship between business capabilities that are under the control of different entities participating in a value added network.

In this description and the following claims, a “business architecture” is defined as the overall design of grouping of business capabilities. A business architecture can represent a business (or portion thereof). For example, a company's business architecture can span externally physical boundaries (e.g., walls, buildings, etc.), internally physical boundaries (e.g., divisions, departments, etc.), and logical boundaries (e.g., a fiscal year end, a perceived service boundary, security etc.). Thus, an outsourced business capability can be viewed as part of the business architecture for a company even though the outsourced business capability is not performed by the company. A business architecture can also be used to represent a value added network (VAN) that includes business capabilities under the control a number of different entities that are configured to interoperate with one another to generate a stream of work. Business architectures can be past, current (as-is), or future (to-be) architectures of a business (or portion thereof) or a VAN. A portion of a business can be a specific sub-network or set of sub-networks of business capabilities the business uses.

Generally, a business capability indicates “what” work is performed and other components within various business layers (e.g., people, process, technology, regulations, etc.) indicate “how” work is performed. Multiple different implementations of “how” work is performed can each contribute to “what” work is performed. For example, an airline can have a capability to “check in passenger”. How checking in a passenger is performed can occur in a number of different ways. For example, a first combination of components from can be blended together to represent online check in, a second different combination of components can be blended kiosk check in, and a third different combination of components can be blended counter check in, for airline flights. Each of online check in, kiosk check in, and counter check in can contribute to a business capability for checking in passengers.

In this description and in the following claims, a “schema” is defined as an expression of a shared vocabulary between a plurality of computer systems, modules, or entities that allows the plurality of computer systems, modules, or entities to process data according the expressed shared vocabulary. A schema can define and describe classes of data using constructs (e.g., name/value pairs) of a schema language. The schema constructs can be used to constrain and document the meaning, usage, and relationships of data types, elements and their content, attributes and their values, entities and their contents, and notations, as used in a specified application, such as, for example, a business capability model. Thus, any computer system, module, or that can access a schema can process data in accordance with the schema. Further, any computer system, module, or entity that can access a schema can compose or modify data for use by other computer systems and/or modules that can also access the schema.

A schema can be utilized to define virtually any data type including logical, binary, octal, decimal, hexadecimal, integer, floating-point, character, character string, user-defined data types, and combinations of these data types used to defined data structures. Some examples of user-defined data types are business capability properties, business capability inputs and outputs, business capability processes, business capability connections, and business capability service level expectations. A data type can also be defined to reference or link to other data types in a schema hierarchy.

eXtensible Markup Language (“XML”) is one way of defining a schema. XML schema can define and describe a class of XML documents using schema constructs (e.g., name/value pairs) of an XML schema language. These schema constructs can be used to constrain and document the meaning, usage, and relationships of data types, elements and their content, attributes and their values, entities and their contents, and notations, as used in XML documents. Thus, schema is also defined to include Document Type Definitions (“DTD”), such as, for example, DTD files ending with a “.dtd” extension and World Wide Web Consortium (“W3C”) XML Schemas, such as, for example, XML Schema files ending with a “.xsd” extension. However, the actually file extension for a particular DTD or XML schema is not important.

In this description and in the following claims a “value added network” (“VAN”) is defined as a plurality of entities (e.g., corporations, organizations, partnerships, etc.) that interoperate to provide a stream of work. Input is received at an initial entity, one or more intermediary entities perform operations, and then a final entity produces output. Along a VAN, output from a prior entity is provided as input to the next entity. Thus, the performance of each entity in a VAN impacts the overall performance of the stream of work. Accordingly, over performance or under performance at any entity can improve or degrade respectively the performance of the VAN and thus impacts the stream of work.

Embodiments of the invention can include a variety of components that are connected to one another over (or be part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

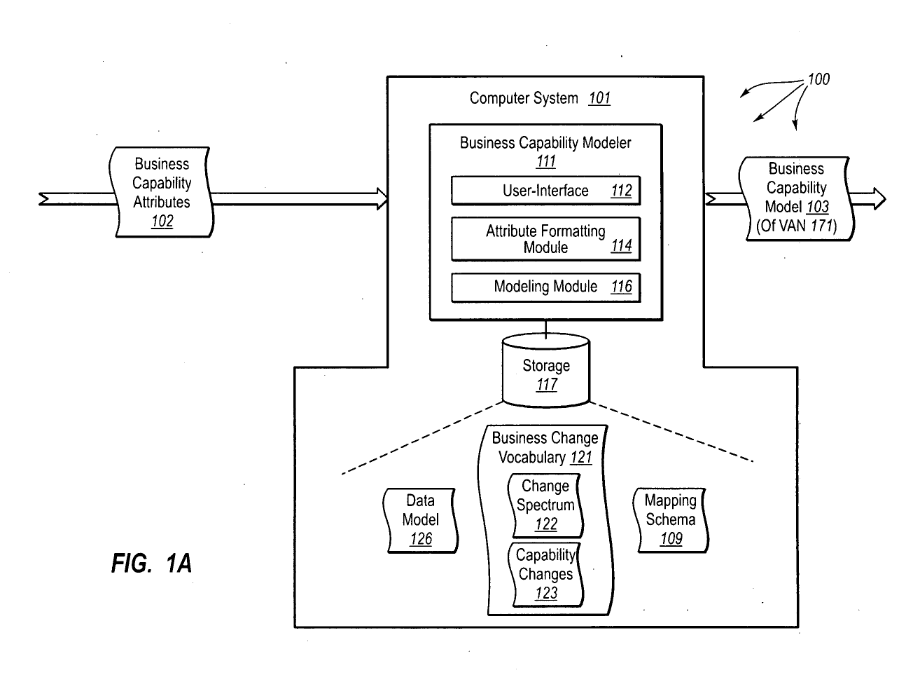

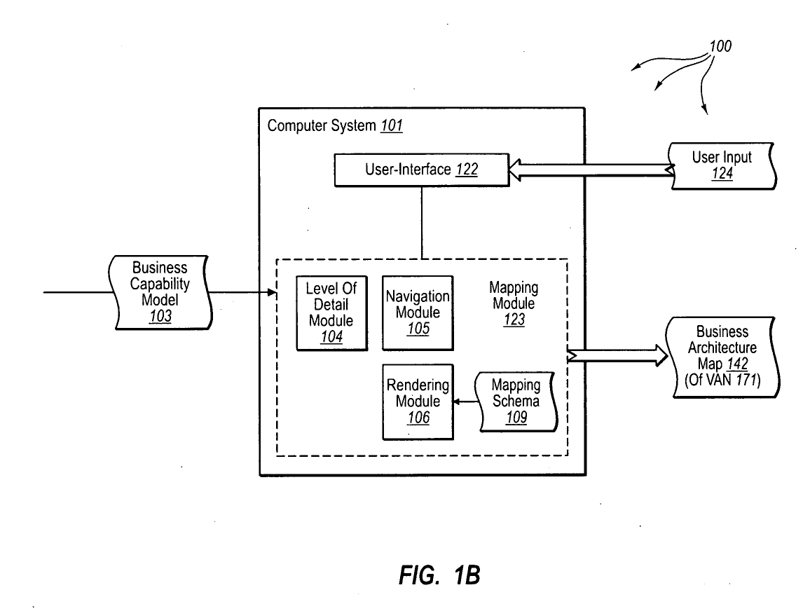

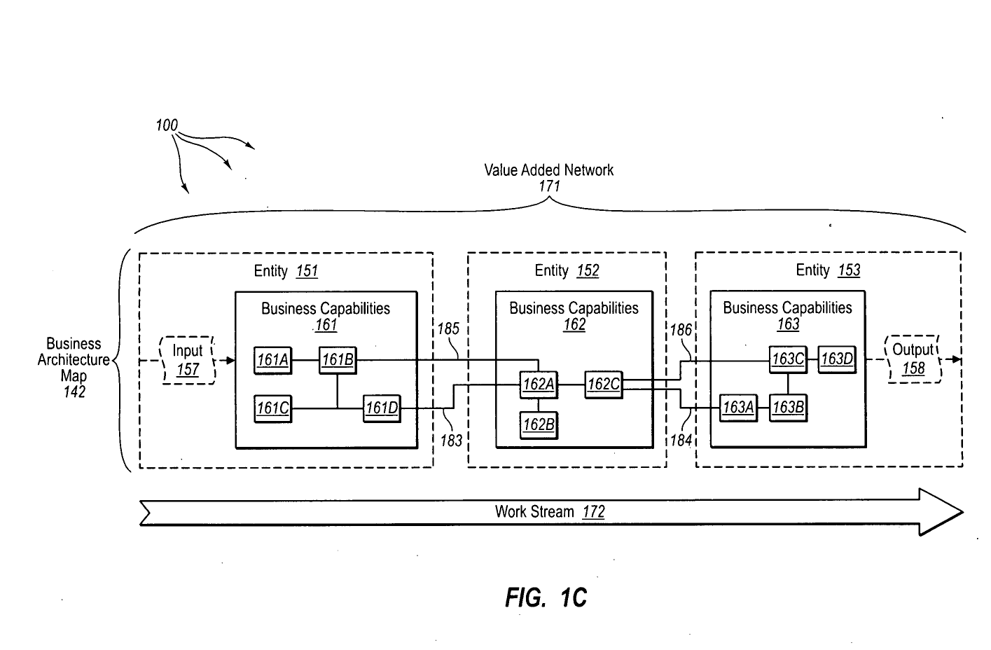

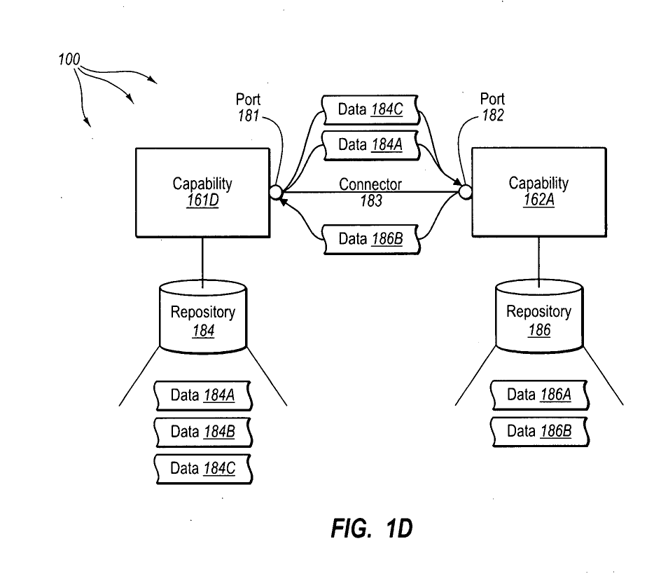

FIG. 1A illustrates an example computer architecture 100 that can be used to flexibly model business functions based on stable criteria. Generally, computer architecture 100 can be configured to model received business capability attributes (e.g., business capability attributes 102) into a business capability model (e.g., business capability model 103). As depicted in computer architecture 100, computer system 101 includes business capability modeler 111 and storage 117. Business capability modeler 111 further includes user-interface 112, attribute formatting model 114, and modeling module 116. User-interface 112 is configured to interface between a computer system user and computer system 101. User-interface 112 can provide an interface for the computer system user to enter data (e.g., business capability attributes) into business capability modeler 111 and to view presented business capability models presented by business capability modeler 111.

As depicted, data model 126, business change vocabulary 121, and mapping schema 109 are stored in storage 117. Data model 126 can be used to model business capability attributed into a business capability model. Thus, data model 126 can be a schema for modeling business capability attributes. Data model 126 can include data format definitions for business capabilities.

Business change vocabulary 121 provides a common vocabulary for entities participating in a VAN to discussed proposed business capability changes objectively.

Attribute formatting module 114 is configured to format business capability attributes in accordance with data formats in data model 126. Accordingly, attribute formatting module 114 can access business capability attributes and format the business capability attributes in accordance with a schema of data model 126. For example, attribute formatting module 114 can format a “fixed cost allocation” attribute to be of a currency data type based on data definitions in a schema of data models 121.

Modeling module 116 is configured to graphically represent formatted business capability attributes as a business capability model. For example, modeling module 116 can model business model 103 from formatted business capability attributes corresponding to one or more business capabilities. Modeling module 116 can present business model 103 at user-interface 112. Accordingly, business capability modeler 111 can model entities participating in a VAN and the relationships between various business capabilities in a VAN.

FIG. 1B illustrates example computer architecture 100 that can be used to associate and visualize schematized business networks. Generally, computer architecture 100 can be configured to receive a business capability model (e.g., business capability model 103) and render a corresponding navigable business map (e.g., business architecture map 142). As depicted in computer architecture 100, computer system 101 includes user-interface 122 and mapping module 103. User-interface 122 is configured to interface between a computer system user and computer system 101. User-interface 122 can provide an interface for the computer system user to enter user-input 114 (e.g., selecting operations to business architecture maps) into mapping module 103 and to view output from mapping module 103.

Generally, mapping module 103 can include modules configured to render visual representations of business models. For example as depicted in computer architecture 100, mapping module 103 includes rendering module 108, mapping schema 109, level of detail module 104, and navigation module 106.

Rendering module 108 is configured to utilize mapping schema 109 to transform schematized business capability attributes and business relationship attributes (e.g., in business capability model 103) into visually renderable (graphically) objects. Mapping schema 109 can provide a translation between schematized business capability attributes and business relationship attributes and corresponding graphical objects.

Level of detail module 104 is configured to control levels of detail within a visual representation of a business model. For example, level of detail module 104 can hide or provide details with a visual representation in response to user-input. Thus, level of detail module 104 can cause less than all the data in business capability attribute and business relationship attribute graphical objects to be rendered.

Level of detail module 104 can also alter a level of detail such that a current level of detail is increased or decreased. For example, level of detail module 104 can focus (or “zoom-in”) on levels of detail as requested by a user (e.g., to drill down on a specified part of a business map). On the other hand, level of detail module 104 can also abstract (or “zoom-out”) levels of detail as requested by a user (e.g., to provide an overview of part of a business map). Level of detail module 104 can also display different portions of a business map with different levels of detail. Thus, a user can visualize greater detail on specified portions of a business map and visualize lesser detail on other portions of a business map. Using varied levels of detail can facilitate drilling down into a specified portion of a business map in increased detail and yet still providing context (i.e., reduced detail surrounding components) for the increased detail portions.

Navigation module 106 is configured to facilitate navigation between business capabilities via relationships between the business capabilities.

Thus generally, computer architecture 100 is configured to receive business capability attributes, model the business capability attributes into a business capability model, and render the business capability model as a navigable business architecture map.

In some embodiments, business models and data format definitions for business capabilities are generally described as indicated in Table 1.

TABLE 1

| | |
|---|---|
| Models | Models serve to group capabilities into distinct groups |
| | that describe a single business. Models can contain all |
| | the capabilities defined for the business as well as how |
| | any defined capabilities relate to each other in terms of |
| | hierarchical decomposition and process flow |
| | relationships. Models facilitate the segmentation of data |
| | in a repository into distinct business models which can be |
| | compared with one another but are separate from each |
| | other. Further, while capability data is defined within a |
| | model, other data elements of the data model are outside |
| | of the model and facilitate the comparison of different |
| | models with one another. |
| Capabilities | Capabilities are individual business functional areas that |
| | are modeled in at least three different ways in the model. |
| | Capabilities can be modeled as individual things with |
| | their own set of properties; as a decomposition hierarchy |
| | of functional areas; and as connected in simple business |
| | process flows. Coarser (or higher level) capabilities can |
| | include a set of more granular (or lower level) |
| | capabilities, such as, for example, when a higher level |
| | capability is decomposed into its constituent parts. The |
| | assignment of properties to capabilities may occur at |
| | multiple levels in a hierarchy, which can be used to |
| | control later data transformations. For example, when a |
| | higher level capability is manipulated through a |
| | transformation, corresponding lower level capabilities' |
| | properties can be considered in the transformation |
| Capability | Capability Inputs and Outputs are the artifacts and events |
| Inputs and | that are consumed and/or produced by business |
| Outputs | capabilities. They represent what is outward and visible |
| | about the behavior of the capabilities. Inputs can be |
| | consumed and outputs can be produced independently of |
| | other inputs and outputs. For example, there is no |
| | requirement that all the inputs for a capability be |
| | consumed before the capability starts. Likewise, there is |
| | no requirement that all the processing of a capability be |
| | completed before an output can be produced. |
| Processes | Processes are networks of business capabilities that are |
| | connected in a flow to illustrate and end-to-end view of a |
| | business process. Processes define the connections |
| | between capabilities that enable larger business functions. |
| | Processes modeled in the data model can refer to cross- |
| | capability processes that represent traversal of boundaries |
| | between capabilities. Further, each implementation of a |
| | capability is also a network of processes. For example, a |
| | capability can be part of a process. The part of the |
| | process can include further, limited scope, capabilities. |
| | Accordingly, process and capability can be view as |
| | decomposing at essentially the same rate. |
| Connections | Connections are used to represent relationships between |
| | business capabilities. Connections can be data |
| | connections over which data, such as, for example, a |
| | business document, can flow between those capabilities. |
| | However, other types of connections are also possible. |
| | Connections may also refer to oversight or management |
| | of a business function, as frequently occurs in regulated |
| | areas of business activity. Connections can be typed such |
| | that connection types are the same across all models. |
| | Typed connections can be used to facilitate model |
| | comparisons. |
| Service | Service levels refer to the general expectation of the |
| Levels | performance of a capability. Service levels attach |
| | performance and accountability attributes to a capability |
| | in varying degrees of formality (e.g., contractual) and |
| | time (e.g., historical, current, target, and maximum). In |
| | some embodiments, a capability includes a verb and noun |
| | phrase (or such a verb-noun phrase can be construed from |
| | the capability description). Service level descriptive data |
| | associated with the capability indicates how well the |
| | capability performs the action implied by the phrase. For |
| | example, Approve Loan Application might have a service |
| | level expectation of 2 days. |

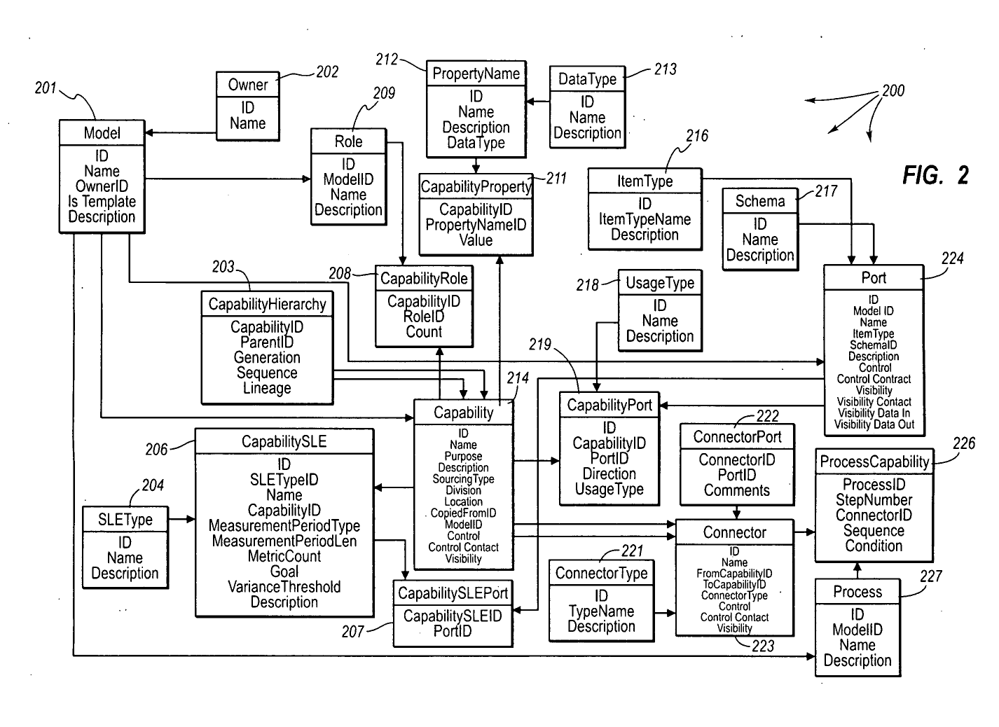

FIG. 2 illustrates a portion of an example capability modeling schema that can be used for efficiently and flexibly business modeling based upon structured business capabilities. Capability modeling schema 200 can include data formats for modeling business capability properties, business capability inputs and outputs, business capability processes, business capability connections, and business capability service level expectations. It should be understood that business capability modeling schema 200 can be one of a plurality of schemas that includes data definitions for modeling a corresponding portions of an organization.

Depicted in FIG. 2, schema 200 includes capability data format 214. Generally, capability data format 214 can be described as indicated in Table 2.

TABLE 2

| Name | Data Type | Description |
|---|---|---|
| ID | int | Key to the capability and is used to relate |
| | | other data entities to this capability. |
| Name | varchar(256) | Name that is unique within a particular model. |
| Purpose | varchar(1000) | Short description of the capability. |
| Description | varchar(8000) | A more detailed description of the capability |
| | | and may explain relationships and properties |
| | | of this capability as well as the capability |
| | | itself |
| SourcingType | int | This field can have three values: Internal, |
| | | Outsourced, or Both. It indicates whether or |
| | | not the capability is performed by an |
| | | organization that is internal (part of) the |
| | | organization that “owns” the model; or an |
| | | organization that is a supplier of the |
| | | capability to the “owner” of the model; or it |
| | | is performed by both internal and external suppliers. |
| Division | varchar(100) | Identifies the business organizational area |
| | | where a capability is performed. |
| Location | varchar(100) | Geographical location where the capability |
| | | is performed. |
| CopiedFromID | int | Indicates the specific capability (and hence |
| | | template model) from which this capability |
| | | was copied. Can be a system-set value. |
| ModelID | int | Indicates the model to which this capability |
| | | belongs. |
| Control | varchar(100) | Indication of controlling entity that controls |
| | | the capability for purposes of regulating |
| | | visibility of the capability |
| Control Contact | Varchar(100) | Name, phone number, and E-mail address of |
| | | the owner, if it is Yes in the Control value |
| Visibility | Complex | Visibility of capability to other entities. |
| | | Visibility can vary per entity. For example, |
| | | visibility can be logical (yes/no) on a per |
| | | entity basis. Thus, visibility can be an array |
| | | of logical values. Different levels of |
| | | visibility can also be configured. For |
| | | example, visibility for general purpose use, |
| | | visibility specifically for use in participating |
| | | in a value added network, read-only access, |
| | | read/write access, etc. |

Depicted in FIG. 2, schema 200 includes capability hierarchy data format 203. Generally, capability hierarchy data format 203 can be described as indicated in Table 3.

TABLE 3

| Name | Data Type | Description |
|---|---|---|
| CapabilityID | int | Links to a capability. |
| ParentID | int | Links to a capability in the same model and |
| | | indicates the parent of this capability in a |
| | | hierarchical view of the model's capabilities. |
| Generation | int | Part of the lineage key which is used in |
| | | certain queries. |
| Sequence | int | Part of the lineage key which is used in |
| | | certain queries. |
| Lineage | varchar(20) | Indicates the entire ancestral lineage of a |
| | | capability and used to perform hierarchical |
| | | sorts. |

Depicted in FIG. 2, schema 200 includes capability property data format 211. Generally, capability property data format 211 can be described as indicated in Table 4.

TABLE 4

| Name | Data Type | Description |
|---|---|---|
| CapabilityID | int | Links to a capability. |
| PropertyNameID | int | Links to a user-defined property. |
| Value | varchar(250) | Value of the property for this capability. |

Depicted in FIG. 2, schema 200 includes capability port data format 219. Generally, capability port data format 219 can be described as indicated in Table 5.

TABLE 5

| Name | Data Type | Description |
|---|---|---|
| ID | int | Key to the capability port and is used to |
| | | relate this port to other entities. |
| CapabilityID | int | Links to the capability that is referenced by |
| | | this relationship. |
| PortID | int | Links to the port that is referenced by this |
| | | relationship. |
| Direction | int | Has three values and indicates whether or |
| | | not the item is input into the referenced |
| | | capability, output from the referenced |
| | | capability, or it flows both directions. |
| UsageType | int | Links to the UsageType entity and indicates |
| | | how the capability uses this item. Examples |
| | | are “Read only”, “Read and update”, |
| | | “Create”, etc. |

Depicted in FIG. 2, schema 200 includes capability role data format 208. Generally, capability role data format 208 can be described as indicated in Table 6.

TABLE 6

| Name | Data Type | Description |
|---|---|---|
| CapabilityID | int | References a specific capability and serves |
| | | to link that capability with a specific role. |
| RoleID | int | References a specific role and links it to |
| | | the referenced capability. |
| Count | int | Indicates the number of people in this role |
| | | that are required to perform this capability. |
| | | A value of ‘0’ indicates that the role |
| | | participation has not been quantified. |

Depicted in FIG. 2, schema 200 includes SLE type data format 204. Generally, SLE type data format 204 can be described as indicated in Table 7.

TABLE 7

| Name | Data Type | Description |
|---|---|---|
| ID | int | Key to the SLEType entity and is used to |
| | | relate this role to CapabilitySLE entities. |
| Name | varchar(100) | Uniquely names the type of service level |
| | | that is described in this entity. This |
| | | entity is assumed to be read-only by |
| | | modelers because the modeling tools |
| | | rely on the value of these entries to |
| | | visualize service levels. Some values |
| | | for service level types include |
| | | “Duration”, “Throughput”, “Monetary |
| | | Cost”, “Time Cost” and “Concurrency”. |
| Description | varchar(4000) | A detailed description of the service level |
| | | type and how to describe specific service |
| | | levels related to capabilities. |

Business capability attributes can also represent Service Levels. Service Level Agreement (“SLA”) attributes can indicate an agreement the business capability is to adhere to. Service Level Expectation (“SLE”) attributes can indicate a service level expectation, such as, for example, a less formal and/or non-contractual based expectation of what a business capability is to do. An SLE can be used to indicate how the success of a corresponding business capability is measured (either subjectively or objectively), who owns the business capability, who is the customer of the capability. An SLE can also be used to indicate what has an impact of the outcome the business capability, such as, for example, people, process, technology, inputs, outputs, etc. For inputs (e.g., people, process, technology, etc), an SLE can indicate the acceptable variation on quality and volume that allow the business capacity to perform its functions and can also trigger events, such as, for example, evaluating other vendors/partners. For outputs, an SLE can indicate the acceptable variations in time, volume, and quality and corresponding thresholds.

An SLE can include an indication of escalation/notification criteria for variations, what is the timeframe for escalation/notification, how escalation/notification impact other timeliness schedules, or success metrics. An SLE can also include potential workarounds if the business capability becomes unavailable.

An SLE can indicate the stability/volatility of the business capability, for example, how often does the capability change, how much of the business capability is related to normal day-to-day activity, and how much of the business capability is exception based. An SLE can also indicate how critical and/or core a business capability is to the overall goals and success of a business. Embodiments of the present invention can be configured to model business capabilities based upon SLE attributes for representing these (as well as other aspects) of SLEs.

Service Level Goal (“SLG”) attributes can indicate business capability goals for specified periods of time, for example, weeks, months, quarters, etc. Service Level Potential (“SLP”) attributes can indicate a capability range (e.g., minimum/maximum units per hours) of a business capability. Service Level History (“SLH”) attributes can indicate how a business capability has performed over a specified period of time, for example, the last week, month, etc. Service Level Delta (“SLD”) attributes can indicate when a capability will change, for example, in the context of a Change Lifecycle, and can indicate a planned delta in the SLE, SLP, and SLG that will result.

Depicted in FIG. 2, schema 200 includes Capability SLE data format 206. Generally, Capability SLE data format 206 can be described as indicated in Table 8.

TABLE 8

| Name | Data Type | Description |
|---|---|---|
| ID | int | Key to the Role entity and is used to |
| | | relate this role to Capability entities. |
| SLETypeID | int | References the SLEType entity and |
| | | identifies a specific way to measure a service |
| | | level. |
| Name | varchar(50) | A unique name for the service level |
| | | definition. |
| CapabilityID | int | References the capability to which this |
| | | service level applies. |
| MeasurementPeriodType | varchar(50) | Names the unit of measure for the service |
| | | level. For “Duration” type service levels, |
| | | this should be a time period. For a |
| | | “Monetary Cost” SLE type, “Dollars” or |
| | | “Thousands of dollars” would be |
| | | appropriate. |
| MeasurementPeriodLen | int | If the SLE type references a |
| | | “Throughput” type of SLE, this field |
| | | indicates the length of the measurement |
| | | period for throughput. |
| MetricCount | int | An actual (current status/performance or |
| | | historical performance) measurement of |
| | | the SLE, such as the number of days of |
| | | duration, the number of items completed |
| | | for throughput, the amount of dollars for |
| | | monetary cost, etc. |
| Goal | int | A target for future performance such as |
| | | the number of days of duration, the |
| | | number of items completed for |
| | | throughput, the amount of dollars for |
| | | monetary cost, etc. |
| VarianceThreshold | int | How much variation in performance |
| | | (e.g., from a goal) is tolerated before a |
| | | variation is noted or notification is sent. |
| | | For example, when a variance threshold |
| | | is exceeded an electronic mail message |
| | | can be sent to appropriate management |
| | | personnel |
| Description | varchar(2000) | A detailed description of the SLE for this |
| | | capability. |

Depicted in FIG. 2, schema 200 includes Capability SLE Port data format 207. Generally, Capability SLE port data format 207 can be described as indicated in Table 9.

TABLE 9

| | | |
|---|---|---|
| CapabilitySLEID | int | References a particular service level for a |
| | | specific capability as described in a |
| | | CapabilitySLE entity. It serves to link a |
| | | particular service level to a particular |
| | | input or output item. |
| PortID | int | References a particular input or output |
| | | item of a capability and links a service |
| | | level to the specific item that is being |
| | | measured. For example, this might |
| | | reference mortgage approvals for a |
| | | duration service level for a mortgage |
| | | processing capability and the entire |
| | | service level definition might thereby |
| | | describe that 100 mortgage approvals are |
| | | completed every day for the mortgage |
| | | processing capability. |

Depicted in FIG. 2, schema 200 includes connector type data format 221. Generally, connecter type data format 221 can be described as indicated in Table 10.

TABLE 10

| Name | Data Type | Description |
|---|---|---|
| ID | int | Key to the ConnectorType entity and is |
| | | used to describe the connection type in the |
| | | Connector entity. |
| TypeName | varchar(50) | A unique name that describes the type of |
| | | connection. Examples are “Collaborative”, |
| | | “Controlling”, “Dependent”, etc. |
| Description | varchar(4000) | A detailed description of the connection |
| | | type and helps modelers understand what |
| | | connections mean in their models. |

Depicted in FIG. 2, schema 200 includes connector data format 223. Generally, connecter data format 223 can be described as indicated in Table 11.

TABLE 11

| Name | Data Type | Description |
|---|---|---|
| ID | int | Key to the Connector entity and indicates the |
| | | connection between two capabilities. This |
| | | key is used to link this connection to other entities. |
| Name | varchar(256) | A comment that is associated with this |
| | | connection between two capabilities. |
| FromCapabilityID | int | References the capability that is the source |
| | | capability. Depending on the ConnectorType, |
| | | the meaning of being the source capability may differ |
| | | slightly. |
| ToCapabilityID | int | References the capability that is the target |
| | | capability. Depending on the ConnectorType, |
| | | the meaning of being the target capability may differ |
| | | slightly. |
| ConnectorType | int | Link to the ConnectorType entity and |
| | | indicates what the relationship between the |
| | | two referenced capabilities really means. |
| | | Examples are “Collaborative”, “Controlling”, |
| | | “Dependent”, etc. |
| Control | varchar(100) | Indication of controlling entity that controls |
| | | the connector for purposes of regulating |
| | | visibility of the connector. |
| Control Contact | varchar(100) | Name, phone number, and E-mail address of the |
| | | owner. |
| Visibility | Complex | Visibility of connector to other entities. |
| | | Visibility can vary per entity. For example, |
| | | visibility can be logical (yes/no) on a per |
| | | entity basis. Thus, visibility can be an array |
| | | of logical values. When a connector is not |
| | | visible to an entity, ports associated with the |
| | | connector are also not visible to the entity. |
| | | Different levels of visibility can also be |
| | | configured. For example, visibility for |
| | | general purpose use, visibility specifically for |
| | | use in participating in a value added network, |
| | | read-only access, read/write access, etc. |

Depicted in FIG. 2, schema 200 includes model data format 201. Generally, model data format 201 can be described as indicated in Table 12.

TABLE 12

| Name | Data Type | Description |
|---|---|---|
| ID | int | Key to the model and is used to relate |
| | | other data entities to this model. |
| Name | varchar(150) | A unique name that identifies the model. |
| OwnerID | int | Points to the owner of the model. An |
| | | owner can own many models. |
| IsTemplate | bit | Controls the ability of a modeler to modify |
| | | this model. If this field is true, it means |
| | | that this model is to be used as a template |
| | | for other models and can thus be used to |
| | | compare the derived models, even after |
| | | properties are changed by modelers in the |
| | | derived models. Therefore, this model |
| | | cannot be changed by normal editors of |
| | | models. Defaults to false |
| Description | varchar(2000) | Textual description of the model. |

Depicted in FIG. 2, schema 200 includes owner data format 202. Generally, owner data format 202 can be described as indicated in Table 13.

TABLE 13

| Name | Data Type | Description |
|---|---|---|
| ID | int | Key to the owner and is used to relate |
| | | other data entities to this owner. |
| Name | varchar(50) | Unique name of the owner. |

Depicted in FIG. 2, schema 200 includes role data format 209. Generally, role data format 209 can be described as indicated in Table 14.

TABLE 14

| Name | Data Type | Description |
|---|---|---|
| ID | int | Key to the Role entity and is used to relate |
| | | this role to Capability entities. |
| ModelID | int | Indicates what model this role entity |
| | | belongs to. |
| Name | varchar(100) | A unique name for the role within this |
| | | model. A role describes a type of person |
| | | or user involved in performing |
| | | capabilities. |
| Description | varchar(2000) | Provides a description of the role and may |
| | | provide guidance to modelers in their |
| | | choice of roles to associate with |
| | | capabilities. |

Depicted in FIG. 2, schema 200 includes property name data format 212. Generally, property name data format 212 can be described as indicated in Table 15.

TABLE 15

| Name | Data Type | Description |
|---|---|---|
| ID | int | Key to the property and is used to relate |
| | | this property to capabilities. |
| Name | varchar(250) | Name of the property and is user defined. |
| Description | varchar(4000) | Description of what the property is and |
| | | how it is to be used to describe |
| | | capabilities. |
| DataType | int | Links to the DataType entity and indicates |
| | | the type of data that is expected when a |
| | | modeler sets a value for this property for a |
| | | capability. If, for example, the modeler |
| | | defines a property named “Fixed Cost |
| | | Allocation”, it is likely that the data type |
| | | for this property would be “Currency”. |

Depicted in FIG. 2, schema 200 includes data type data format 213. Generally, data type data format 213 can be described as indicated in Table 16.

TABLE 16

| Name | Data Type | Description |
|---|---|---|
| ID | int | Key to the data type and is used to |
| | | indicate the data type of a user defined |
| | | property. This is one of a few tables |
| | | that we assume are not modified by |
| | | modelers as the modeling tools rely on |
| | | the values being “known” in order to |
| | | perform validations of property values |
| | | correctly. |
| Name | varchar(20) | A friendly name of the data type. |
| | | Examples are “Integer”, “String”, |
| | | “Currency”, etc. |
| Description | varchar(4000) | Any additional information about the data |
| | | type that would be useful especially in |
| | | guiding user selection of data types for the |
| | | properties that they define. |

Depicted in FIG. 2, schema 200 includes item type data format 216. Generally, item type data format 216 can be described as indicated in Table 17.

TABLE 17

| Name | Data Type | Description |
|---|---|---|
| ID | int | Key to the ItemType and is used to |
| | | relate this item type to the input/output |
| | | items (port entity). This table is |
| | | assumed to be non- modifiable by |
| | | modelers as the tools rely on its specific |
| | | values to process models. |
| ItemTypeName | varchar(150) | A unique name that identifies the usage |
| | | type. Examples include “Electronic |
| | | data”, “Physical item”, “Fax”, etc. |
| Description | varchar(4000) | A more detailed description of the item |
| | | type and how the modeling tools may |
| | | behave when dealing with a specific |
| | | item type. |

Depicted in FIG. 2, schema 200 includes schema data format 217. Generally, schema data format 217 can be described as indicated in Table 18.

TABLE 18

| Name | Data Type | Description |
|---|---|---|
| ID | int | This is the key to the Schema entity and is |
| | | used to relate this item type to the |
| | | input/output items (port entity). |
| Name | varchar(250) | This is a unique name for a schema. |
| Description | varchar(4000) | This may be a detailed description of the |
| | | data content for a data record in the form |
| | | of an XML schema (or some |
| | | simplification thereof). |

Depicted in FIG. 2, schema 200 includes usage type data format 218. Generally, usage type data format 218 can be described as indicated in Table 19.

TABLE 19

| Name | Data Type | Description |
|---|---|---|
| ID | int | Key to the UsageType and is used to relate |
| | | this usage type to the input/output items |
| | | (port entity). This table is assumed to be |
| | | non-modifiable by modelers as the tools |
| | | rely on its specific values to process |
| | | models. |
| Name | varchar(150) | A unique name that identifies the usage |
| | | type. Examples include “Read only”, |
| | | “Read and update”, “Create”, etc. |
| Description | varchar(4000) | A more detailed description of the usage |
| | | type and how the modeling tools may |
| | | behave when dealing with a specific usage |
| | | type. |

Depicted in FIG. 2, schema 200 includes port data format 224. Ports corresponding to a business capability can be used to transfer input into and output out of the corresponding business capability. Generally, port data format 224 can be described as indicated in Table 20.

TABLE 20

| Name | Data Type | Description |
|---|---|---|
| ID | int | Key to the port and is used to relate this port |
| | | to other entities. |
| ModelID | int | Indicates that this port belongs to the related |
| | | model. When dealing with a particular |
| | | model, only the ports associated with the |
| | | model are available to the modeler. A port |
| | | is something that is input to - consumed by - |
| | | a capability or output from - produced by - |
| | | a capability. |
| Name | varchar(256) | A unique name within the specific model. |
| ItemType | int | Links to the ItemType entity which |
| | | indicates the type of input or output, which |
| | | could be electronic data, a physical item, a |
| | | fax, an event, etc. |
| SchemaID | int | If the itemtype indicates that this is an |
| | | electronic data record of some kind, this |
| | | field links to the schema that describes the |
| | | content of the data record. |
| Description | varchar(4000) | A detailed description of the input/output |
| | | item. |
| Control | varchar(100) | Indication of controlling entity that controls |
| | | the port for purposes of regulating the |
| | | visibility of data flow in and out of the connector |
| Control Contact | Varchar(100) | Name, phone number, and E-mail address |
| | | of the owner |
| Visibility | Complex | Visibility of port to other entities. Visibility |
| | | can vary per entity. For example, visibility |
| | | can be logical (yes/no) on a per entity basis. |
| | | Thus, visibility can be an array of logical |
| | | values. When a port is not visible to an |
| | | entity, data flowing (in or out) through the |
| | | port is also not visible. Different levels of |
| | | visibility can also be configured. For |
| | | example, visibility for general purpose use, |
| | | visibility specifically for use in participating |
| | | in a value added network, read-only access, |
| | | read/write access, etc. |
| Visibility Data In | Complex | Visibility of data input to the port. |
| | | Visibility can vary per entity and per data |
| | | type. For example, visibility can be logical |
| | | (yes/no) on a per entity and per data type |
| | | basis. Thus, visibility can be an array of |
| | | logical values (e.g., two-dimensional). |
| | | Entries in the two-dimensional array can be |
| | | limited to entities having visibility to the |
| | | port. Different levels of visibility can also |
| | | be configured. For example, visibility for |
| | | general purpose use, visibility specifically |
| | | for use in participating in a value added |
| | | network, read-only access, read/write |
| | | access, etc. |
| Visibility Data Out | Complex | Visibility of data output from the port. |
| | | Visibility can vary per entity and per data |
| | | type. For example, visibility can be logical |
| | | (yes/no) on a per entity and per data type |
| | | basis. Thus, visibility can be an array of |
| | | logical values (e.g., two-dimensional). |
| | | Entries in the two-dimensional array can be |
| | | limited to entities having visibility to the |
| | | port. Different levels of visibility can also |
| | | be configured. For example, visibility for |
| | | general purpose use, visibility specifically |
| | | for use in participating in a value added |
| | | network, read-only access, read/write |
| | | access, etc. |

Depicted in FIG. 2, schema 200 includes connector port data format 222. Generally, connecter port data format 222 can be described as indicated in Table 21.

TABLE 21

| Name | Data Type | Description |
|---|---|---|
| ConnectorID | int | A reference to the Connector entity and |
| | | serves to link a specific connection |
| | | between two capabilities with a specific |
| | | input/output item. |
| PortID | int | A reference to the Port entity (input/output |
| | | item) and serves to identify the input/ |
| | | output item that flows along a specific |
| | | connection. |
| Comments | varchar(4000) | More detailed commentary about this flow |
| | | of an item along this connection. |

Depicted in FIG. 2, schema 200 includes process data format 227. Generally, process data format 227 can be described as indicated in Table 22.

TABLE 22

| Name | Data Type | Description |
|---|---|---|
| ID | int | Key to the Process entity and is used to |
| | | relate this item type to connector entities, |
| | | and through them to the related |
| | | capabilities in the ProcessCapability |
| | | entity. |
| ModelID | int | Indicates the model that these processes |
| | | belong to. |
| Name | varchar(256) | A unique name for a process within this |
| | | model. |
| Description | varchar(4000) | Describes the process that is modeled by |
| | | this entity and the ProcessCapability |
| | | entities. |

Depicted in FIG. 2, schema 200 includes process capability data format 226. Generally, process capability data format 227 can be described as indicated in Table 23.

TABLE 23

| Name | Data Type | Description |
|---|---|---|
| ProcessID | int | Indicates the process that this capabilities |
| | | and connections belong to. |
| StepNumber | int | Indicates the sequence of this connection |
| | | in the process and is used to sort the |
| | | process steps for rendering in a visual |
| | | model. |
| ConnectorID | int | Links to the Connector entity and through |
| | | it to the source and target capabilities of a |
| | | process flow from a source capability to a |
| | | destination capability. |
| Sequence | int | Indicates the sequence of a connection |
| | | within a step, thereby supporting process |
| | | flows that have multiple paths through it. |
| | | To define a path where one leg has more |
| | | steps (or flows through more capabilities) |
| | | than another leg, the shorter leg is |
| | | represented by entries in this table that |
| | | reference the same connector but different |
| | | StepNumbers. |
| Condition | varchar(4000) | Stores comments on what the conditions |
| | | are that drive the process. |

It should be understood that schema 200 is merely one example of a business capability modeling schema. It would be apparent to one skilled in the art, after having reviewed this description, that embodiments of the present invention can be used with a wide variety of other business capability modeling schemas, in addition to schema 200. Further, modeling business capabilities does not require that capability attributes for all the data formats in schema 200 be accessible. For example, a capability and connecter can be used to model a business capability based on capability data format 214 and connector data format 223, without accessing capability attributes corresponding to other data formats. Thus, schema 200 defines data formats for business capability attributes that are accessed, but does not require that all data formats be populated to generate a business capability model.

Accordingly, in some embodiments, the business capabilities for an organization are included together in a collection of business capabilities modeled in accordance with a schema. A collection of business capabilities can be represented as a (e.g., structured or schematized) business capability model. An organization can formulate business capability attributes representing current performance of their collection of business capabilities. A modeling application (not shown) can receive the business capability attributes (e.g., from a business capability business layer) and model the business capability attributes into a business capability model. A business capability model can be represented in a variety of different ways depicting various levels of detail (e.g., up to the level of detail of the business capability attributes). A business capability model can be configured visually for output at a user-interface and/or can be retained as data for further processing.

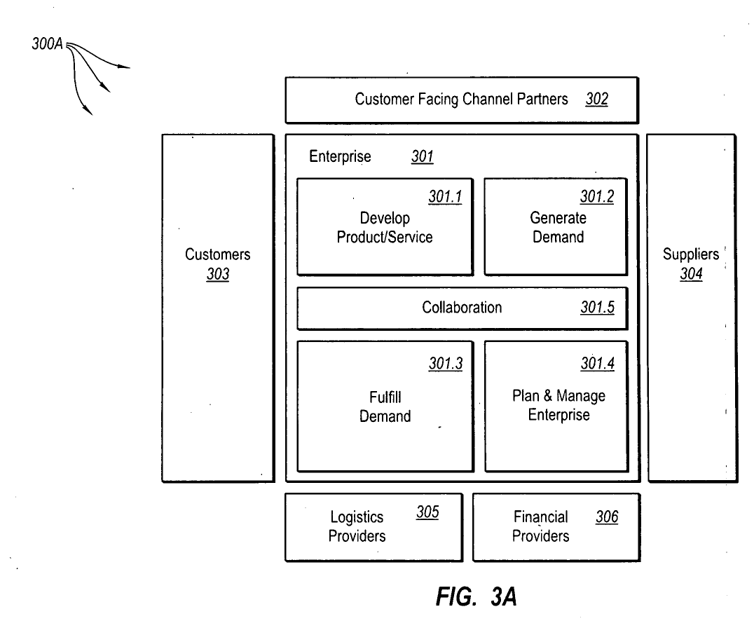

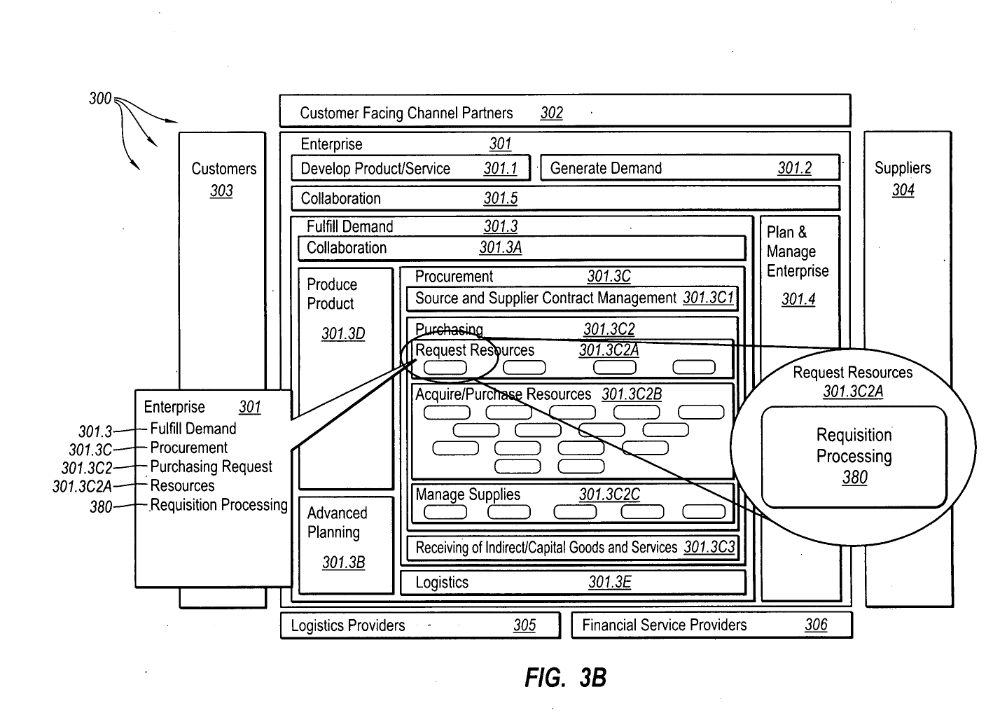

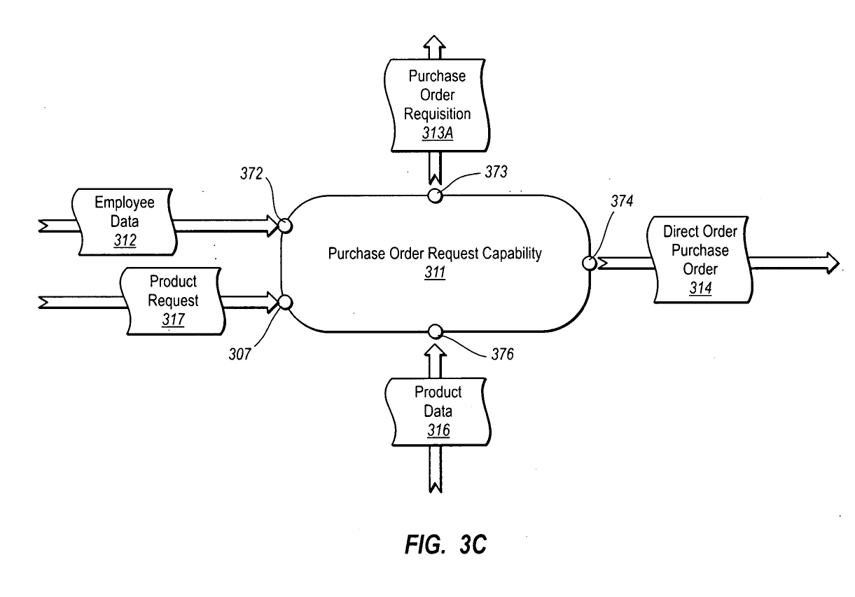

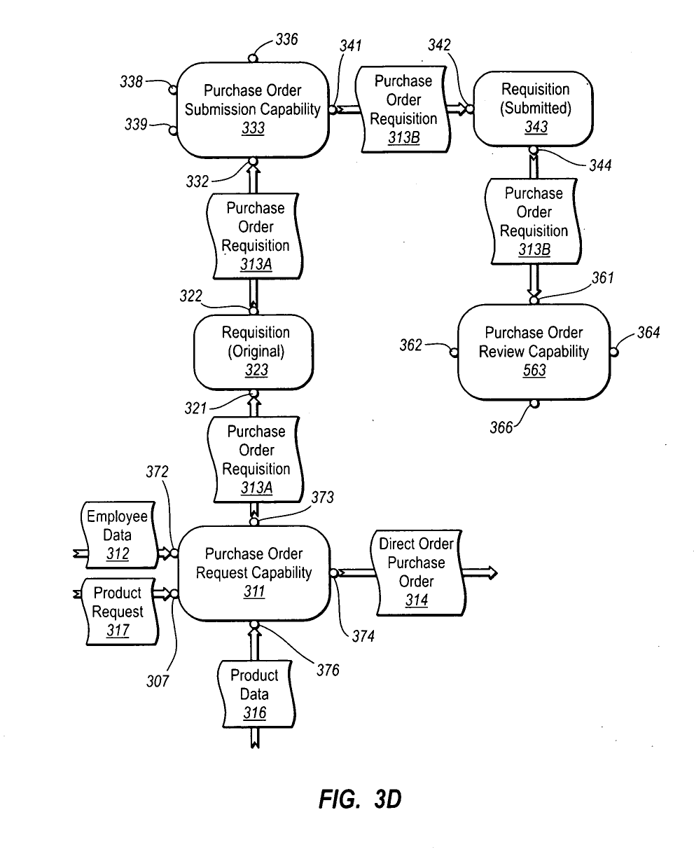

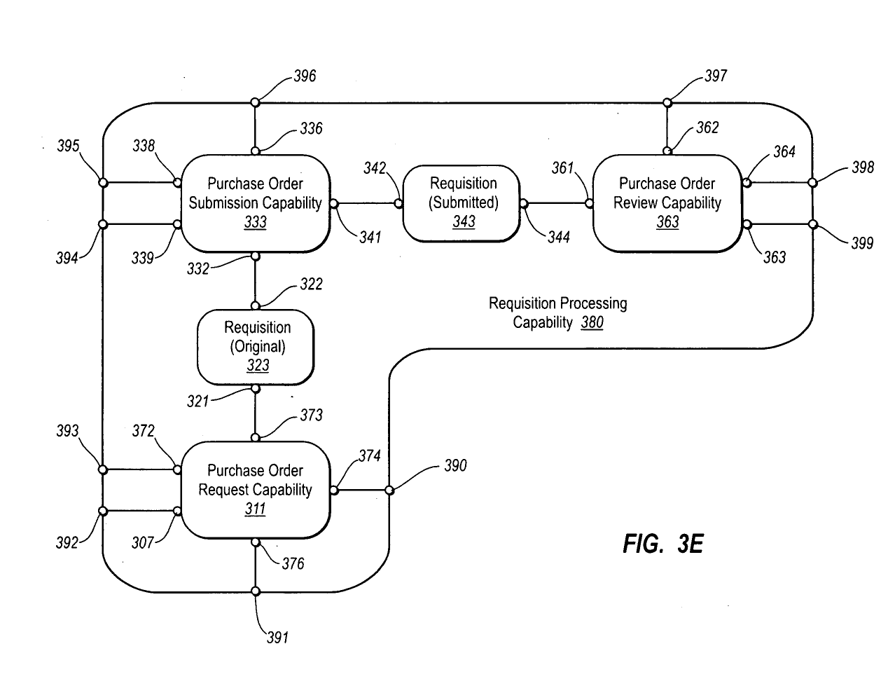

Levels of detail can be used to represent (potentially interconnected) sub-capabilities that contribute to the performance other capabilities. FIGS. 3A through 3E depicted collections of business capabilities having various levels of detail and interconnection. Referring now to FIG. 3A, FIG. 3A depicts an example visual representation 300 (e.g., a model) of a collection of business capabilities for an organization. As depicted, the visually rendered business capabilities in visual representation 300 are rendered with varied levels of detail. For example, customer facing channel partners 302, customers 303, suppliers 304, logistic providers 305, and financial providers 306 are rendered with less detail. On the other hand, enterprise 301 is rendered with more detail, depicting other business capabilities that contribute to the performance of enterprise 301. For example, develop product service 301.1, generate demand 301.2, fulfill demand 301.3, plan and manage enterprise 301.4, and collaboration 301.5 are expressly rendered within enterprise 301. Thus, visual representation 3000 represents that develop product service 301.1, generate demand 301.2, fulfill demand 301.3, plan and manage enterprise 301.4, and collaboration 301.5 contribute to the performance of enterprise 301.

Turning now to FIG. 3B, FIG. 3B depicts visual representation 300 with further levels of detail. FIG. 3B is representative of the way business capabilities can be broken down/decomposed into other capabilities. For example, fulfill demand 301.3 is increased by a number of levels of detail. Fulfill demand 301.3 includes collaboration 301.3A, advanced planning 301.3B, procurement 301.3C, produce product 301.3D, and logistics 301.3E. Thus, collaboration 301.3A, advanced planning 301.3B, procurement 301.3C, produce product 301.3D, and logistics 301.3E contribute to the performance of fulfill demand 301.3 (and as a result also contribute to the performance of enterprise 301).

Procurement 301.3C is further detailed to include source and supplier contract management 301.3C1, purchasing 301.3C2, and receiving of indirect/capital goods and services 301.3C3. Thus, contract management 301.3C1, purchasing 301.3C2, and receiving of indirect/capital goods and services 301.3C3 contribute to the performance of procurement 301.3C (and, as a result, also contribute to the performance of fulfill demand 301.3 and performance of enterprise 301).

Purchasing 301.3C2 is further detailed to include request resources 301.3C2A, acquire/purchase resources 301.3C2B, and manage supplies 301.3C2C. Thus, request resources 301.3C2A, acquire/purchase resources 301.3C2B, and manage supplies 301.3C2C contribute to the performance of purchasing 301.3C2 (and as a result also contribute to the performance of procurement 301.3C, fulfill demand 301.3, and performance of enterprise 301). Requisition processing 380 is a further sub-capability of request resources request resources 301.3C2A.

Business capability models can also represent data that flows into and data that flows out of the modeled business capabilities. For example, FIG. 3C illustrates an example of a modeled business capability. FIG. 3C, includes purchase order request capability 311 (e.g., modeled based on structured capability data format). Purchase order request capability 311 includes ports 372, 376, and 307 (e.g., modeled based on a structured port data format) that receive employee data 312, product data 316, and product request 317 respectively (e.g., from other business capabilities). Purchase order request capability 311 can use employee data 312, product data 316 and product request 317 to formulate a purchase order request.

Purchase order request capability 311 includes ports 373 and 374 (e.g., modeled based on the structured port data format) that can send purchase order requisition 313A and direct order purchase order 314 respectively (e.g., to other business capabilities). Purchase order request capability 501 can include logic that determines, based on one or more of receive employee data 312, product data 316 and produce request 317, whether purchase order requisition 513A and/or direct order purchase order 314 is to be sent.

Thus, embodiments of the present invention can also utilize models of a network of business capabilities. A first business capability is modeled based upon formatted business capability attributes. A second business capability is modeled based upon the formatted business capability attributes. A connection between the first business capability and the second capability is modeled based upon the formatted business capability attributes.

FIG. 3D illustrates a first view of an example of a network of modeled business capabilities including purchase order request capability 311. As depicted, purchase order request capability 311 (a capability) sends purchase order request 313A out of port 373 to requisition 323 (a connector).

Requisition 323 receives purchase order requisition 313A at port 312. Requisition 323 sends purchase order requisition 313A out of port 322 to purchase order submission capability 333. Thus, requisition 323 transfers purchase order requisition 313A from purchase order request capability 311 to purchase order submission capability 333. Accordingly, a connector can be viewed as a business capability wherein the capability of the connector is to transfer data between other capabilities.

Purchase order submission capability 333 receives purchase order requisition 313A at port 332. Purchase order submission capability 333 includes other ports, including ports 336, 338, 339, and 341. Each of the ports 336, 338, 339, and 341 can be used to send data to and/or receive data from other capabilities or connectors. More specifically, purchase order submission capability 332 sends purchase order 313B out of port 341 to requisition 343 (a connector). Although similar to purchase order requisition 313A, purchase order requisition 313B can differ from purchase order 313A as a result of processing at purchase order submission capability 332.

Requisition 343 receives purchase order requisition 313B at port 342. Requisition 343 sends purchase order requisition 313B out of port 344 to purchase order review capability 363. Purchase order review capability 563 receives purchase order requisition 313B at port 361. Purchase order review capability 363 includes other ports, including ports 362, 364, and 366. Each of the ports 362, 364, and 366 can be used to send data to and/or receive data from other capabilities or connectors.

Although one-way ports and connectors have been depicted in FIG. 3D, it should be understood that embodiments of the present invention can include two-way ports and/or two-way connectors. For example, it may be that, from time to time, requisition 323 also transfers data from purchase order submission capability 333 (coming out of port 332 and into port 322) to purchase order request capability 311 (coming out of port 321 and into port 373). Similarly, it may be that, from time to time, requisition 343 also transfers data from purchase order review capability 363 (coming out of port 361 and into port 344) to purchase order submission capability 333 (coming out of port 342 and into port 341).

A network of business capabilities can also be represented in a manner that abstracts the data exchanged between various business capabilities and connectors in the business capability network. Further, in some embodiments and as previously described, a network of more granular business capabilities (or those at higher levels of detail) can be used to model a more coarse business capability (or those at lower levels of detail). FIG. 3E illustrates a second view of the example of a network of modeled business capabilities in FIG. 3D representing requisition processing capability 380 (from FIG. 3B).

The network of business capabilities in FIG. 3E abstracts out the data that is exchanged between the business capabilities and connections in FIG. 3D. FIG. 3E further depicts that the more granular business capabilities and connections in FIG. 3D can be used to model a more coarse requisition processing capability 380. Ports 390-399 represent that requisition processing capability 380 can exchange data with other business capabilities and connectors, for example, included in request resources 301.3C2A (of FIG. 3B) or in part of some other general procurement network of business capabilities.

Although particular models have been described with respect to FIGS. 3A-3E, embodiments of the invention are not so limited. Embodiments of the invention can be practiced with virtually any type of model that represents business capabilities and/or business processes.

For example, referring back to FIG. 1C depicts business architecture map 142 for value added network 171. Value added network receives input 157, performs work stream 172, and produces output 158. As depicted, business architecture map 142 maps business capabilities and business capability relationships for entities 151, 152, and 153. Entities 151, 152, and 153 can be differently controlled businesses that are participants in VAN 171.

Each entity includes a plurality of internally related business capabilities. For example, entities 151, 152, and 153 include business capabilities 161 (161A, 161B, 161C, and 161D), 162 (162A, 162B, and 162C), and 163 (163A, 163B, 163C, and 163D) respectively. Business capabilities under the control of different entities can also connect to one another. For example, business capabilities 161B and 161C connect to business capability 162A and business capability 162C connects to business capabilities 163A and 163C.

Within a VAN, inter-entity connections can be used to transfer data between capabilities under the control different entities. A port at each end a connector can send and/or receive data to a correspond port at the other end of the connector. For example, FIG. 1D depicts a more detailed view of capabilities 161D and 162A from VAN 171. As depicted, connector 183 connects capability 161D and capability 162A to one another.

Port 181 is configured to send data to and(/or) receive data from capability 162A. Similarly, portion 182 is configured send data to and(/or) receive data from capability 161D. Repository 188 stores data used by the capabilities under the control of entity 151, including capability 161D. Similarly, repository 189 stores data used by capabilities under the control of entity 152, including capability 162A.

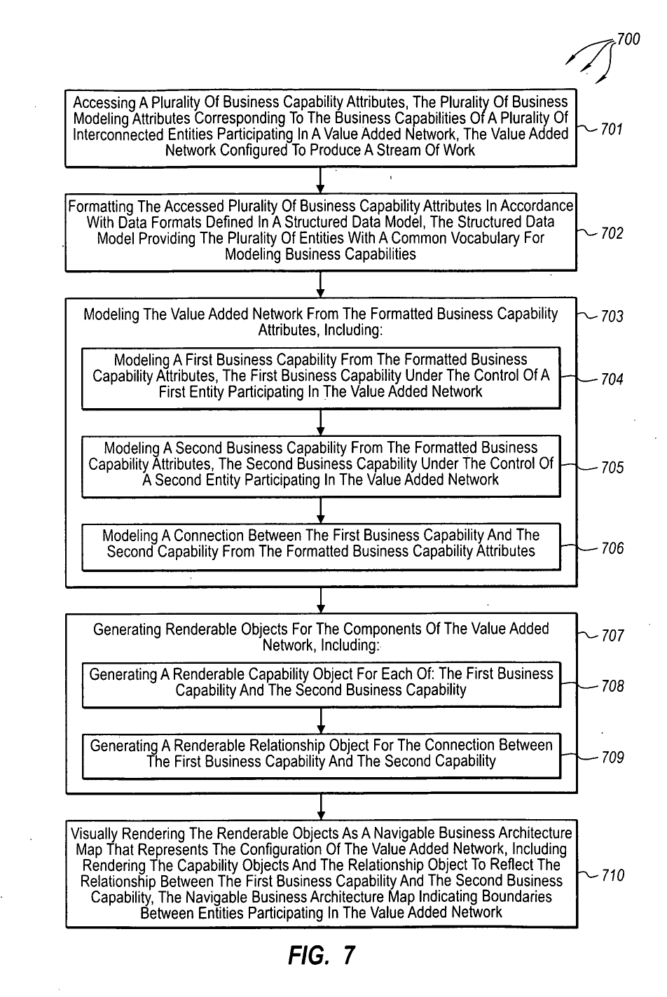

FIG. 7 illustrates an example flowchart of a method 700 for visualizing a model of a value added network. Method 700 will be described with respect to the components and data in computer architecture 100.

Method 700 includes an act of accessing a plurality of business capability attributes, the plurality of business modeling attributes corresponding to the business capabilities of a plurality of interconnected entities participating in a value added network, the value added network configured to produce a stream of work (act 701). For example, computer system 101 can access business capability attributes 102. Business capability attributes 102 can correspond to the interconnected entities (151, 152, and 153) participating in VAN 171 to produce work stream 172.

Method 700 includes an act of formatting the accessed plurality of business capability attributes in accordance with data formats defined in a structured data model, the structured data model providing the plurality of entities with a common vocabulary for modeling business capabilities (act 702). For example, attribute formatting module can format business capability attributes in accordance with data formats defined in data model 126. Data model 126 (e.g., similar to 200) provides common vocabulary for entities 151, 152, and 153 to model business capabilities.

Method 700 includes an act of modeling the value added network from the formatted business capability attributes (act 703). For example, modeling module 116 can model VAN 171 from the formatted business capabilities.

Modeling the value added network can include an act of modeling a first business capability from the formatted business capability attributes, the first business capability under the control of a first entity participating in the value added network (act 704). For example, modeling module 116 can model business capability 161D under the control of entity 151. Modeling the value added network can include an act of modeling a second business capability from the formatted business capability attributes, the second business capability under the control of a second entity participating in the value added network (act 705). For example, modeling module 116 can model business capability 162A under the control of entity 152. Modeling the value added network can include an act of modeling a connection between the first business capability and the second capability from the formatted business capability attributes (act 706). For example, modeling module 116 can model connector 183 between business capability 161D and business capability 162A.

Method 700 includes an act of generating renderable objects for the components of the value added network (act 707). For example, mapping module 123 can use mapping schema 108 to generate business architecture map 142 from business capability model 103. Generating renderable objects for the components of the value added network can include generating a renderable capability object the first business capability and the second business capability (act 708). For example, mapping module 123 can utilize mapping schema 109 to generate a renderable object for business capabilities 161D and 162A. Generating renderable objects for the components of the value added network can include generating a renderable relationship object for the connection between the first business capability and the second capability (act 709). For example, mapping module 123 can utilize mapping schema 109 to generate a renderable object for connector 183.

Method 700 includes an act of visually rendering the renderable objects as a navigable business architecture map that represents the configuration of the value added network, including rendering the capability objects and the relationship object to reflect the relationship between the first business capability and the second business capability, the navigable business architecture map indicating boundaries between entities participating in the value added network (act 709). For example, computer system 101 can visually render business architecture map 142 at a computer monitor or other display. A user can then navigate to different portions of VAN 171 using business architecture map 142. Navigation can include traversing connections between business capabilities (potentially under the control of different entities) and changing the level of detail.

For example, a user can initially select capability 162A as the point of focus within the navigable business architecture map 142. A user can subsequently enter input 124 at user-interface 122 that selections business capability 161D. In response to user input 124, mapping module 123 can shifting focus from the first business capability to the second business capability. Further, when a business capability has focus it can be rendered with increased detail. Thus, when shifting focus from capability 162A to 161D, the level of detail for capability 162A can be decreased and the level of detail for capability 161D can be increased.

The visibility of capabilities, connectors, and ports can be limited within a VAN. The not all entities within a VAN can necessary access all the capabilities, connectors, ports, and data for other entities in the VAN. Each entity can control other entity's access to capabilities, connectors, ports, and data under its control.

Within a value added business network, different portions of a stream of work can be performed at entities under different types and levels of control. For example, it may be that each entity in a value added business network is separately owned and all entities are of a relatively equal size. Thus, entities can not necessarily dictate or control operations at other entities. In other value added business networks, one entity many own all or a portion of another entity or may be so large so as to at least partially be able to dictate and control operations at one or more other entities. In other value added business networks, operational control can be shared or work in shoe cooperative manner. Thus, an entity that controls the visibility of capabilities, connectors and ports can be the owner or can be delegated to control visibility by another entity with actual control.

Accordingly, entity 151 can control the visibility of capability 161D, port 181, and data in repository 188 to the capabilities of other entities in Van 171. The visibility of port 181 and data 184A, 184B, and 184C can be defined in accordance with port data format 224. The visibility of capability 161D can be defined in accordance with capability data format 214. For example, entity 151 can make capability 161D, port 181, and data 184A and 184C visible to entity 152 at least for purposes of participating in VAN 171.

Similarly, entity 152 can control the visibility of capability 162A, port 182, and data in repository 189 to the capabilities of other entities in VAN 171. The visibility of port 182 and data 186A and 186B accordance with port data format 224. The visibility of capability 162A can be defined in accordance with capability data format 214. For example, entity 152 can make capability 162A, port 182, and data 186A and 186B visible to entity 151 at last for purposes of participating in VAN 171.

Connector 183 can be controlled by one or both of capabilities 161D and 162A. The visibility of connector 183 can be defined in accordance with connector data format 223.

In addition to permitting visibility for purposing of participating VANs, entities can permit other types of visibility to capabilities, connectors, ports, and data for other purposes. For example, even though entities 151 and 153 are not directly connected to one another, entity 151 can make business capabilities 161 visible to entity 153. Thus, entity 153 can use access to capabilities for purposes of measuring its performance in value added network 171. For example, with knowledge of capabilities 161, entity 153 may be able determine if changes to capabilities 163 are worthwhile to align their performance for participation in VAN 171.

Accordingly, navigation of a business architecture map can be limited based on visibility settings. Visibility settings can be used to limit what one entity can access of another entity's business capabilities, connectors, ports, and data. For example, if entity 152 is navigating business architecture 142, their visibility into business capability 161D can be limited by visibility settings put in place by entity 151.

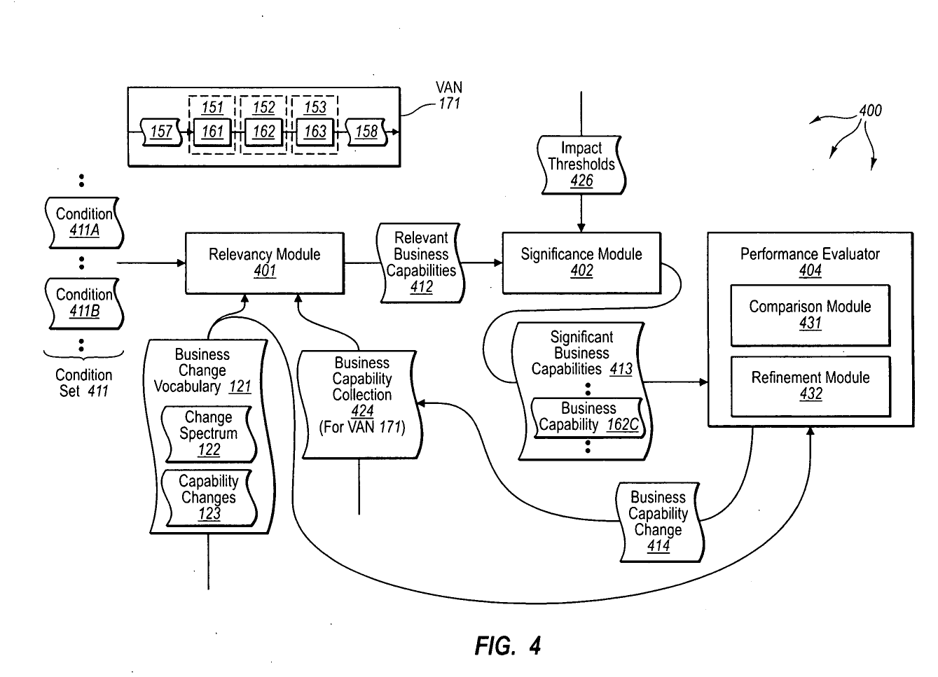

Referring now to FIG. 4, FIG. 4 illustrates an example computer architecture 400 that facilitates structured implementation of capability changes in a value added network. Computer architecture can be used from the perspective of a particular entity in a value added network. Computer architecture 400 includes relevance module 401, significance module 402, and performance evaluator 404. Each of the depicted components can be connected to one another over (or be part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, relevancy module 401 is configured to receive a set of conditions and a collection of business capabilities for a VAN. A VAN can include a variety of different types of business related entities, such as, for example, a corporation (profit or non-profit), a partnership, a limited partnership (“LP”), a limited liability partnership (“LLP”), a limited liability corporation (“LLC”), a sole proprietorship, etc. Based on a pre-defined business change vocabulary, relevancy module 401 can determine and output any business capabilities that are relevant to the set of conditions.

A set of conditions can represent an existing environment in which a VAN is operating. For example, a set of conditions can represent a current configuration of business capabilities, connectors, and ports of a VAN providing a stream of work. A set of conditions can also represent a proposed alteration to an existing business environment. For example, an entity can propose alterations to capabilities, connections, and ports under its control, to attempt to better align its performance within a VAN. A set of conditions can map to an external exception or variance resulting from the activities of customers, competitors, partners, suppliers, regulatory agencies, financial services organizations, other participants in a VAN, etc. A set of conditions can also represent an internal exception or variance relative to existing business expectations, metrics, or plans, such as, for example, participation in a VAN. An internal exception or variance can result from creation of products and services, demand generation, fulfillment of demand, planning and managing, etc, within an organization.

A set of conditions can also represent normal business operations. For example, an organization can proactively (as opposed to reactively) manage its change and make decisions about what change is appropriate prior to the occurrence of any exceptions or variances.

Generally, a pre-defined common vocabulary provides a mechanism for a plurality of different entities to consider changes in business capabilities and/or between business capabilities (e.g., their connectors) in a uniform manner. A pre-defined common vocabulary also provides a mechanism to produce consistent repeatable results for considered changes in business capabilities.

A pre-defined business change vocabulary can include a spectrum of change along a plurality of axes. One axis can represent the significance of a change within a range of significance. For example, the significance of a change can range from a managerial adjustment to keep a capability within specific guardrails (i.e., tolerance boundaries relative to pre-defined metrics for over/under performance) for defined performance goals, to a more significant adjustment to change a capability beyond define guardrails (e.g., project with an existing and a targeted image), and to change resulting in a true transformation of work/output (i.e., an innovation). Another axis can represent a level of organizational coordination for implementing the change with a range of levels of organization. For example, organization levels can range from individual to department/division to business unit to enterprise to industry.

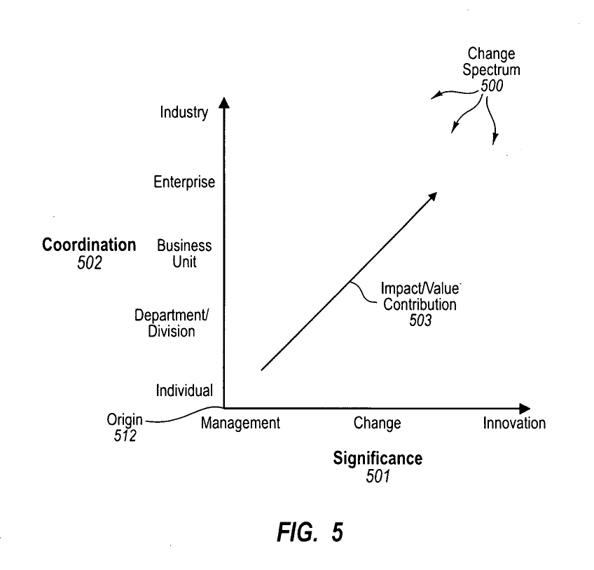

In some embodiments, axes can be used to represent a grid. The grid can be used to estimate the cost associated with a change. The cost can then be compared against models implementing the change to determine if the change is worthwhile, for example, in view of time cost and constraints, disruption impact, risk, financial impact (e.g., results in increase revenue, savings, cuts costs, etc.). For example, referring briefly to FIG. 5, FIG. 5 depicts change spectrum 500. As depicted, change spectrum 500 includes significance axis 501 and coordination axis 502. Along significance axis 501 the significance of change increases from management to change to innovation. Likewise, along coordination axis 502 the level of coordination for implementing a change increases from individual to department/division to business unit to enterprise to industry.

Impact/value contribution 503 generally represents an impact and/or value to an organization of performing a change of a specified significance and a specified level of coordination. Thus, as the significance of a change increases so does the impact/value. For example, there is likely more impact/value to implementing an innovation for a business capability than to adjust management to better meet existing goals for a business capability. Likewise, as the organization coordination for change increases so does the impact/value. For example, there is likely more impact/value to change an enterprise wide business capability than to change a department business capability. Thus, as change moves away from origin 512 (either vertically or horizontally) the impact/value associated with change increases. Generally, impact/value represents impact and/or value on organizational resources, such as, for example, one or more of financial, material, technical, personnel resources, time, disruption impact, and risk.

Further, impact/value contribution 503 generally indicates that impact/value increases as significance and level of coordination move away from origin 512. However, there is not necessarily a linear relationship between significance and level of coordination. Depending on the business capabilities for an organization and proposed changes to the business capabilities, the relationship between significance and level of coordination can result in a logarithmic impact/value curve, an exponential impact/value curve, or a curve based on virtually any other function.

When the cost for a change is under impact/value contribution 503 (or any other impact/value curve) then there is at least some objective evidence that the change is justified and/or worthwhile to an entity participating in a VAN. For example, below an impact/value cure, an entity (of a VAN) may make more from changed business capabilities than it costs to implement the change. On the other hand, when the cost for a change is over impact/value contribution 503 (or any other impact/value curve) then there is at least some objective evidence that the change is not justified and/or worthwhile to a VAN. For example, above an impact/value cure, an entity (or the VAN) may not recoup from changed business capabilities what it costs to implement the change.

A pre-defined business change vocabulary can also define business capability changes. Business capability changes are activities that entities in a VAN can implement to change the functionality of current business capabilities. Business capability changes can include how to alter an existing business capability to change the functionality of the existing business capability. For example, a business capability change can indicate how to transform a paper payroll system into a computer based payroll system.

Embodiments of the invention can include considering changes to and changing a variety of different types of business capabilities. Business capability changes can be considered and implemented for economic driver/core capabilities that directly impact VAN performance metrics. For example, if a VAN produces a stream of work to process raw material into widgets, business capabilities related to processing raw materials into sub-components, produce widgets from the sub-components, production efficiency of widgets, widgets produced to the specific preferences or requirements of some or all customers, etc., can be considered economic driver/core capabilities

Business capability changes can also be considered and implemented for enabling or infrastructure capabilities. Enabling or infrastructure capabilities are part of a business and have to be performed. However, enabling or infrastructure capabilities do not necessary correlate with more important VAN performance metrics. For example, referring back to the example of producing widgets, payroll is likely a required capability. However, payroll does impact the production of widgets to the extent of the other previously listed capabilities.

Business capability changes can also be considered and implemented for management capabilities, including executive managers and managers at other levels of a VAN.

Significance module 402 is configured to receive relevant business capabilities. Based on impact thresholds, significance module 402 can identify and output significant business capabilities (from among the relevant business capabilities) that impact performance of an entity participating in a VAN. An impact threshold indicates a requisite impact on performance that a business capability is to have before a change to the business capability is considered. An impact threshold can be a number, percentage, or some other indicator. Accordingly, a significant business capability (e.g., an economic driver or core business capability) is a business capability that satisfies an impact threshold (and thus likely has an increased impact on the performance of a VAN) relative to impact/value contribution.

Significance module 402 can compare the performance impact of each relevant business capability to appropriate impact thresholds. Business capabilities that satisfy appropriate impact thresholds can be forwarded on to performance evaluator 404. On the other hand, business capabilities that do not satisfy appropriate impact thresholds are dropped. Thus, impact thresholds can be used to filter out capabilities that, while relevant, have a reduced impact on a VAN's performance.

Significance module 402 can determine the performance impact of a business capability in a variety of different ways. For example, significance module 402 can derive a capability's impact on VAN performance from the number of inter-entity and intra-entity connections to other business capabilities. That is, well connected capabilities can have a greater impact on performance than lesser connected capabilities. As such, considering changes to well connected capabilities can potentially be viewed as more worthwhile.

Significance module 402 can also consider the types of data (e.g., product sales data, financial agreement data, human resources data, etc) that pass through a business capability when deriving a capability's impact on performance. When data related to economic drivers and core functions of a VAN pass through a business capability, this can indicate that the business capability has an increased impact on performance. For example, when a VAN produces widgets, a business capability that obtains subcomponents from suppliers can have an increased impact on the performance of the organization. On the other hand, for the same VAN, a business capability that inputs and/or outputs human resources data likely has less of an impact on the performance of the value added network.

Alternately, a collection of business capabilities can expressly indicate (e.g., economic driver or core) capabilities that have a relatively significant impact on VAN performance.

Performance evaluator 404 is configured to receive significant business capabilities. Based on the pre-defined business change vocabulary, performance evaluator 104 can determine if a change to any significant business capabilities would improve the performance of the VAN with at least a basic understanding of impact (disruption), cost, and risk. Any change that would result in improved performance can be incorporated back into the collection of business capabilities. Accordingly, embodiments of the invention can determine that a proposed capability change to a VAN is or is not worthwhile based on cost associated with a proposed change (e.g., represented in change spectrum 400) compared to any benefit associated with implementing the change.

As depicted, performance evaluator 404 includes comparison module 431 and refinement module 432. Generally, comparison module 431 is configured to compare received significant business capabilities to potential business capability changes to the received significant business capabilities. For example, a shipping capability can be compared to a proposed modified version of the shipping capability. Comparison module 431 can compare based on measureable business objectives, such as, for example, cost, production efficiency, etc. Results of a comparison can reveal if changing a business capability would improve performance for the owning entity and/or a VAN. Potential business capability changes can be implemented from defined capability changes in a pre-defined business change vocabulary.

If a potential business capability change results in improved performance, the change can be incorporated back into the collection of business capabilities. Refinement module 432 is configured to refine a collection of business capabilities to implement a business capability change for one or more business capabilities. Refinement can include altering how a business capability does its work. Accordingly, refinement module 432 can formulate a business capability change that is integrated back into a collection of business capabilities.

A business capability change can address a set of conditions relative to a change in business environment (e.g., a change at another entity participating in a VAN), and can include addressing an exception or variance relative to existing business expectations, metrics, or plans indicated in an internal or external change trigger event. A business capability change can also be used to proactively adjust prior to the occurrence of any exceptions or variances.

Thus, generally, a potential change to a VAN's business capabilities be analyzed and a potential change implemented in view of a set of conditions representing a business environment. Embodiments of the invention can be used to analyze and evaluate the impact of a potential business capability change in view of a set of conditions. Based on analysis and evaluation of business capability changes, business capability For example, if a business capability change yields improved results during simulated implementation, the business capability change can be applied for actually implementation within a VAN.

Further, a pre-defined business change vocabulary provides a mechanism for any entity participating in a VAN to consider business capability changes in a uniform manner. For example, business change vocabulary 121 provides a mechanism for entities in VAN 171 to consider business capability changes to business capability collection 424 in a uniform manner. Further, a pre-defined business change vocabulary provides a mechanism to produce consistent repeatable results for considered business capability changes to a business capability collection. For example, business change vocabulary 121 provides a mechanism to produce consistent repeatable results for considered business capability changes to business capability collection 424.

In some embodiments, entities in a VAN lack full visibility into capabilities, connectors, ports, and data under the control of other entities within the VAN. Thus, these entities may have to make capability change decisions based on sets of conditions from the visibility they do have (even when the visibility into some other entities is reduced or non existant).

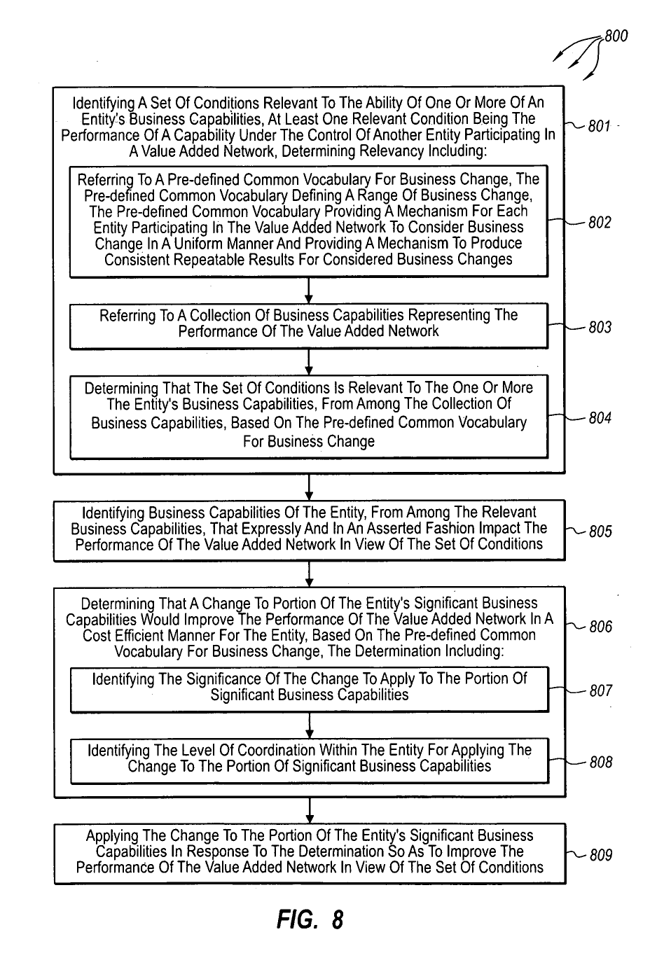

FIG. 8 illustrates an example flowchart of a method 800 for implementing a structured capability change to some aspect of a VAN. Method 800 will be described with respect to the components and data in computer architecture 400.

Method 800 includes an act of identifying a set of conditions relevant to the ability of one or more of the entity's business capabilities, at least one relevant condition being the performance of a capability under the control of another entity participating in a value added network (act 801). For example, condition set 111 can include one or more conditions, including conditions 411A and 411B, indicating a portion of an operating environment VAN 171 from the perspective of entity 152. Relevancy module 401 can determine that condition set 411 is relevant to the functionality of relevant business capabilities 412 (e.g., a portion of the capabilities 162. For example, relevancy module 401 can determine that the performance of one or more capabilities in capabilities 161 is relevant to the performance of one or more capabilities in capabilities 162.

Determining relevancy includes an act of referring to a pre-defined common vocabulary for business change, the pre-defined common vocabulary defining a range of business change, the pre-defined common vocabulary providing a mechanism for each entity participating in the value added network to consider business change in a uniform manner and providing a mechanism to produce consistent repeatable results for considered business changes (act 802). For example, relevancy module 401 can refer to business change vocabulary 121, including change spectrum 122 and capability changes 123. Change spectrum 122 can define a range of capability changes, such as, for example, as depicted in change spectrum 400.

Determining relevancy includes an act of referring to a collection of business capabilities representing the performance of the value added network (act 803). For example, relevancy module 401 can refer to business capability collection 424. Business capability collection 424 can be a model/amp representing the performance of VAN 171.

Determining relevancy includes an act of determining that the set of conditions is relevant to the one or more the entity's business capabilities, from among the collection of business capabilities, based on the pre-defined common vocabulary for business change (act 804). For example, relevancy module 401 can determine that condition set 111 is relevant to relevant business capabilities 412 (a subset of business capabilities 162) based on business change vocabulary 121.

Method 800 includes an act of identifying business capabilities of the entity, from among the relevant business capabilities, that expressly and in an asserted fashion impact the performance of the value added network in view of the set of conditions (act 805). For example, significance module 402 can utilize impact thresholds 426 to identify significant business capabilities 413 of entity 152 from relevant business capabilities 412 of entity 152. Relevant business capabilities 412 that satisfy impact thresholds 426 are included in significant business capabilities 413. For example, business capability 162C can be identified as a significant business capability. Thus, in some embodiments, a capability change is considered (potentially only) for capabilities that are relevant to responding to a set of conditions and that significantly impact an entities performance in a VAN. Accordingly, resources are not expended to evaluate capabilities that, while relevant, do not significantly impact an entities response to a set of conditions.

Method 800 includes an act of determining that a change to portion of the entity's significant business capabilities would improve the performance of the value added network in a cost efficient manner for the entity, based on the pre-defined common vocabulary for business change (act 806). For example, performance evaluator 404 can determine that a business capability change 414 to business capability 162 would improve entity 152's performance in a cost efficient manner based on business change vocabulary 121. Performance evaluator 404 can refer to capability changes 123 to generate potential capability changes (including business capability change 414) to significant business capabilities 413.

Determining that a change to portion of the entity's significant business capabilities would improve the performance includes an act of identifying the significance of the change to apply to the portion of significant business capabilities (act 807). For example, performance evaluator 404 can identify the significance of business capability change 414 (e.g., on a significance axis of change spectrum 122) to business capability 162C. Determining that a change to a portion of the entity's significant business capabilities would improve the performance includes an act of identifying the level of coordination within the entity for applying the change to the portion of significant business capabilities (act 808). For example, performance evaluator 404 can identify the level of coordination within entity 152 to implement business capability change 414 (e.g., on coordination axis within change spectrum 122) to business capability 162C.

Performance evaluator 404 can associate a cost with business capability change 414 based on the significance and level of coordination for implementation in change spectrum 122. Refinement module 432 can simulate implementation of business capability change 414 to business capability 162C into business capability collection 424. Performance evaluator 404 can then identify any improved performance in VAN 171 resulting from simulated implementation of business capability change 414. Comparison module 431 can evaluate any identified improved performance against the associated cost of business capability change 414 to determine if business capability change 414 is worthwhile (e.g., increases revenue, cuts costs, etc.) for actual implementation.

If comparison module 431 determines that business capability change 414 is not worthwhile, entity 152 can choose not to implement business capability change 414. On the other hand, if comparison module 431 determines that business capability change 414 is worthwhile, entity 152 can choose to implement business capability change 414 resulting in a permanent change to business capability 162C. Accordingly, method 200 can include an act of applying the change to the portion of the significant business capabilities in response to the determination so as to improve the performance of the value added network in view of the set of conditions (act 209). For example, refinement module 432 can apply business capability change 414 to business capability 162C so as to improve the performance of VAN 171.

In some embodiments, a business capability change is a change in a business capability's ability to adapt. For example, a pre-defined business change vocabulary can also include a spectrum of adaptability ranging from increased ability to adapt to decreased ability to adapt. Within this specification and the following claims, “agility” is defined as ready to adapt to changing business requirements within specific time constraints relevant to the specific business capability. Within this specification and the following claims, “flexibility” is defined as ready to adapt to changing business requirements with no specifics relative to time or timeliness. Within this specification and the following claims, “consistent” and “durable” are defined as not ready or able to adapt to changing business requirements.

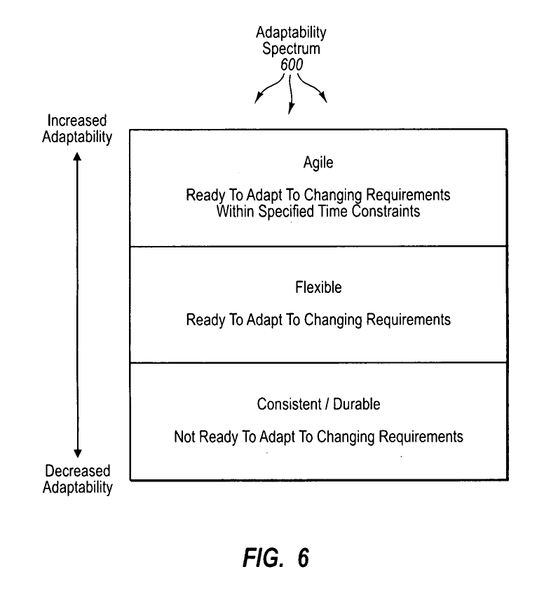

Accordingly, in some embodiments, a pre-defined business change vocabulary can also include a spectrum of adaptability ranging from agile (increased adaptability) to consistent/durable (decreased adaptability). “Flexibility” can be included within the pre-defined business change vocabulary. Flexibility indicates more adaptability than consistent/durable but less adaptability than agile. Referring briefly to FIG. 6, FIG. 6 depicts adaptability spectrum 600. As depicted, adaptability spectrum 600 includes a range of adaptabilities from agile to consistent/durable. Adaptability spectrum 600 can be included along with change spectrum 122 in business change vocabulary 121. In these embodiments, capability changes 123 can also indicate mechanisms for changing the adaptability of business capabilities.

Accordingly, a pre-defined business change vocabulary can also define adaptability changes. Adaptability changes are activities that an entity participating in a VAN can implement for business capabilities to alter adaptability of the business capabilities within an adaptability spectrum. Adaptability changes can include how to alter the adaptability of a business capability to make a VAN capability more or less adaptable. For example, an adaptability change can indicate how transform a flexible business capability into an agile business capability (or vice versa).

Thus, embodiments of the invention can include considering changes to and changing the adaptability of a variety of different types of business capabilities. For example, adaptability changes can be considered and implemented for economic driver/core capabilities, enabling or infrastructure capabilities, and management capabilities. For example, business capability change 414 can represent a change to the adaptability of business capability 162C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer architecture, a method for visualizing a model of a value added network, the method comprising:
an act of accessing a plurality of business capability attributes, the plurality of business modeling attributes corresponding to the business capabilities of a plurality of interconnected entities participating in a value added network, the value added network configured to produce a stream of work;
an act of formatting the accessed plurality of business capability attributes in accordance with data formats defined in a structured data model, the structured data model providing the plurality of entities with a common vocabulary for modeling business capabilities;
an act of modeling the value added network from the formatted business capability attributes, including:
an act of modeling a first business capability from the formatted business capability attributes, the first business capability under the control of a first entity participating in the value added network;
an act of modeling a second business capability from the formatted business capability attributes, the second business capability under the control of a second entity participating in the value added network; and
an act of modeling a connection between the first business capability and the second capability from the formatted business capability attributes; and
an act of generating renderable objects for the components of the value added network, including:
an act of generating a renderable capability object for each of: the first business capability and the second business capability; and
an act of generating a renderable relationship object for the connection between the first business capability and the second capability; and
an act of visually rendering the renderable objects as a navigable business architecture map that represents the configuration of the value added network, including rendering the capability objects and the relationship object to reflect the relationship between the first business capability and the second business capability, the navigable business architecture map indicating boundaries between entities participating in the value added network.

2. The method as recited in claim 1, wherein the act of formatting the accessed business capability attributes in accordance with data formats defined in a structured data model comprises an act of formatting the accessed business capability attributes in accordance with data formats in a business capability modeling schema.

3. The method as recited in claim 1, wherein the act of modeling a first business capability for the formatted business capability attributes comprises an act of modeling the first business capability based on schematized business capability attributes.

4. The method as recited in claim 1, wherein the act of modeling a first business capability for the formatted business capability attributes comprises an act of modeling the first business capability to include a port for exchanging data with other business capabilities.

5. The method as recited in claim 1, wherein the act of modeling a connection between the first business capability and the second capability based upon the formatted business capability attributes comprises an act of modeling the connection based on schematized business capability attributes.

6. The method as recited in claim 1, wherein the act of modeling a connection between the first business capability and the second capability based upon the formatted business capability attributes comprises an act of modeling a inter-entity connection between the first business capability and the second capability, wherein the first business capability is under the control of a first entity participating in the value added network and the second business capability is under the control of a second different entity participating in the value added network.

7. The method as recited in claim 6, further comprising:
an act of limiting visibility of the second business capability to other entities participating in the value added network based on schematized visibility data for the second business capability.

8. The method as recited in claim 1, wherein the act of generating renderable objects for the components of the value added network comprises an act of utilizing a mapping schema to transform modeled business attributes into renderable objects.

9. The method as recited in claim 1, further comprising
an act of receiving user input selecting the renderable capability object for the first business capability as the point of focus within the navigable business architecture map;
an act of receiving user input selecting the capability object for the second business capability; and
an act of shifting focus from the first business capability to the second business capability.

10. The method as recited in claim 1, further comprising
an act of reducing the level of detail for the first business capability upon shifting focus to the second business capability; and
an act of increasing the level of detail for the second business capability upon shifting focus to the second business capability.

11. In a computer architecture, a method for implementing a structured change to some aspect of a value added network that is under the control of an entity participating in the value added network, the method comprising:
identifying a set of conditions relevant to the ability of one or more of the entity's business capabilities, at least one relevant condition being the performance a capability under the control of another entity participating in a value added network, determining relevancy including:
an act of referring to a pre-defined common vocabulary for business change, the pre-defined common vocabulary defining a range of business change, the pre-defined common vocabulary providing a mechanism for each entity participating in the value added network to consider business change in a uniform manner and providing a mechanism to produce consistent repeatable results for considered business changes;
an act of referring to a collection of business capabilities representing the performance of the value added network; and
an act of determining that the set of conditions is relevant to the one or more the entity's business capabilities, from among the collection of business capabilities, based on the pre-defined common vocabulary for business change;
an act of identifying business capabilities of the entity, from among the relevant business capabilities, that expressly and in an asserted fashion impact the performance of the value added network in view of the set of conditions;
an act of determining that a change to portion of the entity's significant business capabilities would improve the performance of the value added network in a cost efficient manner for the entity, based on the pre-defined common vocabulary for business change, the determination including:
an act of identifying the significance of the change to apply to the portion of significant business capabilities; and
an act of identifying the level of coordination within the entity for applying the change to the portion of significant business capabilities; and
an act of applying the change to the portion of the entity's significant business capabilities in response to the determination so as to improve the performance of the value added network in view of the set of conditions.

12. The method as recited in claim 11, wherein the act of identifying a set of conditions relevant to the ability of one or more of the organization's business capabilities comprises an act identifying a set of conditions that indicate a business environment for the value added network.

13. The method as recited in claim 11, wherein the act of referring to a pre-defined common vocabulary for business change comprises an act of referring to a pre-defined common vocabulary that defines a range of business change within a multi-axis spectrum.

14. The method as recited in claim 11, wherein the act of referring to a pre-defined common vocabulary for business change comprises an act of referring to a pre-defined common vocabulary that defines how to alter business capabilities to cause a change in the functionality of a business capabilities.

15. The method as recited in claim 14, wherein the act of referring to a pre-defined common vocabulary that defines how to alter business capabilities comprises an act of referring to a pre-defined common vocabulary that defines adaptability changes for changing between different adaptabilities in a range of adaptability.

16. The method as recited in claim 11, wherein the act of referring to a collection of business capabilities representing the performance of the value added network comprises an act of referring to a collection of business capabilities represented with various different levels of detail.

17. The method as recited in claim 11, wherein the act of referring to a collection of business capabilities representing the performance of the value added network comprises an act of referring to a network of interconnected business capabilities, including capabilities that are connected between different entities.

18. The method as recited in claim 11, wherein the act of determining that a change to a portion of the significant business capabilities would improve the performance of the value added network comprises an act associating a cost with the change based on the location of the change in the change spectrum.

19. The method as recited in claim 11, wherein the act of identifying a set of conditions comprises an act of identifying that the entity has limited visibility into the capabilities, connectors, ports, and data of one or more other entities participating in the value added network.

20. In a computer architecture, a method for modeling a value added network, the method comprising:
an act of accessing a plurality of business capability attributes, the plurality of business modeling attributes corresponding to the business capabilities of a plurality of interconnected entities participating in a value added network, the value added network configured to produce a stream of work, the business modeling attributes including visibility attributes used to limit the inter-entity visibility of capabilities, connectors, ports, and data within the value added network;
an act of formatting the accessed plurality of business capability attributes, including the visibility attributes, in accordance with data formats defined in a structured data model, the structured data model providing the plurality of entities with a common vocabulary for modeling business capabilities;
an act of modeling the value added network from the formatted business capability attributes, including:
an act of modeling a first business capability from the formatted business capability attributes, the first business capability under the control of a first entity participating in the value added network;
an act of modeling a second business capability from the formatted business capability attributes, the second business capability under the control of a second entity participating in the value added network, the second business capability modeled such that only data used in generation of the stream of work is visible to the first entity; and
an act of modeling a connection between the first business capability and the second capability from the formatted business capability attributes.
